(19) United States
(12) Patent Application Publication
(10) Pub. No.: US 2008/0273224 A1
(43) Pub. Date: Nov. 6, 2008

(54) SYSTEM AND METHOD OF PRINT MANAGEMENT

(75) Inventors: David Maulsby, Calgary (CA); Ian Grahan, Calgary (CA); Vince Mullan, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: PREO SOFTWARE INC., Calgary (CA)

(21) Appl. No.: 12/110,027

(22) Filed: Apr. 25, 2008

Related U.S. Application Data
(60) Provisional application No. 60/915,193, filed on May 1, 2007.

(51) Int. Cl. G06F 3/12

(52) U.S. Cl. 358/1.15

(57) ABSTRACT

A computer-implemented print management system and method includes the application of business rules to a print situation, and the application of meta-rules to the business rules to choose zero or more business rules to fire. The meta-rules may suppress the business rule or modify actions associated with a business rule. The actions associated with a business rule may include one or more of the following: present information to the user, request information from the user, request a choice or decision by the user, or allow, modify or deny the print job. The print situation, the chosen business rule and the user interaction may be recorded to a print usage database, which may be used in subsequent print situations.

### CROSS-REFERENCE TO RELATED APPLICATIONS

The present application claims the priority benefit of U.S. Provisional Patent Application No. 60/915,193 filed May 1, 2007, entitled “System and Method of Print Management”, the entire contents of which are incorporated herein by reference.

### FIELD OF THE INVENTION

The present invention relates to a computer-implemented method and system for managing print functions in an organization.

### BACKGROUND

Large organizations such as business enterprises, educational, government and medical institutions often have large expenditures relating to printing paper documents, and often experience difficulty with control over the flow of information by printed documents.

Various print management systems exist and include simple user tracking systems and systems which capture billing information for organizations to allocate cost within the organization or to bill clients with photocopying costs. Other systems monitor and limit print behavior by users. For example, only certain individuals may be permitted to process expensive print jobs such as multicolor printing, or very large print jobs. However, such systems do not modify user behavior, they simply place limits on user behavior in order to reduce cost.

In addition, prior art print management systems are rigidly applied, so that rules are strictly enforced, and if they exist, rule exceptions are simply rules themselves. Alteration or variation of the rules requires reprogramming or other active intervention.

By way of example, an organization could define rules that implement a policy to reduce the cost of color printing, where if the user submits a print job in color, and the job costs more than $1.00, the user will be advised to resubmit the job in black & white, provide a reason for printing in color, or charge the job out to a client.

Encoding print policies as conditional rules enables the system to respond to a variety of end-user behaviors, and facilitates adapting to the organization's behavior, by writing new rules. This approach, however, does not readily adapt to individuals' behavior, especially as it evolves over time in response to the system's interventions. In the field, the effectiveness of rules-based print management systems has been undermined by end-user objections to rigid implementation of policies, which in turn has led end-users to circumvent the system by inferring and then avoiding conditions that trigger rules. For example, if a rule prevents or hinders any print job of more than 100 pages, end-users will split their jobs into 50-page chunks.

Therefore, there is a need in the art for a method and system which mitigates the difficulties of the prior art.

### SUMMARY OF THE INVENTION

The present invention relates to a system which monitors printing activity by end-users within the organization, computes estimates of the cost of such activity, and assesses activity in relation to the organization's stated policies for controlling the cost of print and the flow of information. In one embodiment, the system may record end-user behavior at the level of individual print jobs and capture data such as that concerning the configuration, routing and costing of each job. Collectively, such historical data represents the organization's printing behavior, which may be summarized at various levels, including by individual user, department, division, user job category, or geographic location. Aggregated data may be interpreted or analyzed to enable an organization to understand the usage and cost of print; in particular, it can be used to identify and evaluate controllable factors that contribute to cost, for example the use of color, or the printing of email messages and other volume or cost-intensive print behavior.

The insight an organization obtains into factors that drive print spending can motivate “print policies” to reduce costs. For example, end-users may be advised to avoid printing in color except for external audiences, or they may be given a quota for printing certain types of documents such as email. The present invention provides a rules-based system to communicate policies to end-users and obtain compliance through adaptive behavior modification.

By evaluating and adjusting rules in “real time”, that is, as print jobs are being submitted, a system of the present invention can be used not only to track user behavior, but also to modify it, and even to prevent certain behaviors. In practice, this means that rules can ensure users charge jobs out to clients, and can prevent unauthorized printing of documents that match specified signatures.

Therefore, in one aspect, the invention may comprise a computer-implemented method of print management initiated upon detection of a print job requested by an end-user, said method comprising:

(a) obtaining information about the print job and the end-user to create a print situation;

(b) applying a set of business rules to the print situation to create a candidate set of zero or more business rules;

(c) applying a set of meta-rules to the candidate set of business rules to choose zero or more business rules to fire;

(d) if a business rule is chosen to fire, applying an action associated with the chosen business rule;

(e) observing a user response to the action; and

(f) recording the print situation, the candidate set of business rules, the meta-rules matched, the business rule chosen, and user response, all to a print usage database.

In one embodiment, the information about the end-user comprises a user profile and user print history. In one embodiment, the step of applying a set of meta-rules to the candidate set of business rules may result in removal of the business rule from the candidate set of business rules, or suppression or modification of the action associated with a chosen business rule.

The meta-rules may account for the user profile, the user print history, or other circumstances in order to determine which, if any, business rule should fire.

In another aspect, the invention may comprise a server based print management system comprising:

(a) a business rule database,

(b) a meta-rules database;

(c) a print usage database; and

(d) a communication interface configured to communicate with a client based system comprising a client print system, a rules engine, a usage data collector, and a user interface;

wherein the usage data collector is configured to observe end-user print behavior and record it to the print usage database, and the rules engine is configured to analyze a print job situation by applying business rules to the situation, and meta-rules to the applied business rules and situation.

In another aspect, the invention may comprise a client based print management system for use with a client print system, said print management system comprising:

(a) a rules engine;

(b) a usage data collector;

(c) a user interface; and

(d) a communication interface configured to communication with a server based system comprising a business rules database, a meta-rules database, and a print usage database;

(e) wherein the usage data collector is configured to create a print situation and observe end-user behavior, and record information to the print usage database, and wherein the rules engine is configured to receive the print situation and apply business rules to the situation, and apply meta-rules to the applied business rules and the situation, and if a business rule is chosen to fire, execute an action associated with the chosen business rule, the action as modified by the application of the meta-rules thereto.

In another aspect, the invention may comprise a print management medium storing a computer executable program for implementing any method or system described or claimed herein.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 shows a schematic representation of one embodiment of a rules-based system of the present invention.

FIG. 2 shows a schematic flowchart of a print job processing through a rules engine of the present invention.

FIG. 3 shows a schematic overview of a rules filtering process

FIG. 4 shows a schematic flowchart of a process of evaluating a business rule set on print job and usage history.

FIG. 5 shows a schematic flowchart of a method of evaluating meta-rules on candidate business rules and situation.

FIG. 6 shows an example of user dialog generated for a sample business rule (BR-605).

FIG. 7 shows an example of Modal Dialog Generated by Behavior Interface

FIG. 8 shows an example of a priority lattice of business rules.

### DETAILED DESCRIPTION OF PREFERRED EMBODIMENTS

The present invention relates to print management method and system. In general, the rules-based system components of the present invention may create, test and modify business and meta-rules, track all print usage and the application of rules, and user responses thereto, or provide reports on print usage and behavior modification to a variety of authorized users.

When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

The present invention comprises a rules-based system for implementing a conditional rule set, referred to herein as business rules and capable of implementing flexible, adaptive policies with a second layer of rules-based logic, which functions to modify the actions of business rules layer.

This second layer of rules are referred to herein as “meta-rules”, because they modify other rules. Meta-rules applied to the business rules in the example above introduce adaptation to individual user's responses. For example, an organization may implement two business rules where (1) if the user submits a print job in color, and the job costs more than $1.00, the user will be advised to resubmit the job in black & white, and (2) if the user submits a print job in color, and the job costs more than $5.00, hold the job in queue and ask the user to resubmit the job in black & white, provide a reason for printing in color, or charge the job out to a client.

These business rules may then be modified in practice by meta-rules. For example, (1) if the user has ignored more than 90% of requests to comply with the business rule, hold the job in queue and require the user to charge the job out to a client or resubmit it in black & white, or (2) if the user has complied with more than 80% of requests to comply with the business rule, do not show the advice, so as to avoid wasting the user's time.

If a print job matches a business rule, the system will then check any associated meta-rules to determine whether they match the print job or the user's history of compliance with business rules, or any other scenario that could affect application of the business rule. In the example above, if the user has almost never complied, the meta-rule modifies the business rule, escalating the intervention. On the other hand, if the user has consistently complied, the meta-rule actually suppresses the intervention, in effect allowing the user an occasional exemption from the rule. Meta-rules can also be used to vary the messaging that end-users receive, and to avoid repeating the same advice so often that users become inured to it.

In one embodiment, the meta-rules layer may also include mechanisms for grouping business rules into classes, such that a meta-rule can be defined to apply to an entire class of rules: for example, the two meta-rules exemplified above could refer to “any cost-reduction rule”.

A given print job may match several rules. For reporting purposes, the system records each match of a rule. However, it may be inappropriate to act on all matches, as in the example of color printing above, where it would be confusing to take both actions in the event that both special cases matched. The meta-rules layer may also control selection and prioritization of rules for “firing” (that is, for taking action), such that at most one intervention occurs.

When a rule fires, the user is presented with some form of interaction on their computer or workstation: advice may appear in a pop-up text balloon, and options to revise or resubmit a job may appear in a modal dialog. The system records the user's response to dialogs, and aggregates this data to establish individual and collective patterns of behavior and rates of compliance with each rule. The organization's management and administrative staff can view reports on the frequency of various behaviors (e.g. color printing of emails) as they vary over time, correlated with the presentation of and response to behavior-modification dialogs. This enables them to judge the effectiveness of their business rules for implementing policy, and to define meta-rules that fine-tune the implementation of policy.

In one embodiment, a method of the present invention may also comprise back-testing new rules on historical data before implementing them, to assist with defining effective business rules.

Therefore, the methods described herein enable an organization to define and implement flexible print management policies that modify end-user behavior at the point of real-time decision-making, and track the effectiveness of the behavior modification program.

One embodiment of the present invention includes, among other components, a subsystem for rules-based assessment and modification of end-user behavior, referred to herein as the rules engine. This subsystem comprises a means for expressing business and meta-rules, a means of collecting print job data, and an inference engine that includes evaluators for business and meta-rules on print job data.

In one embodiment, the rules engine modifies its own behavior through the evaluation and firing of “meta-rules”, which govern the interpretation and firing of business rules. Using meta-rules enables the system to adapt its behavior in useful and interesting ways:
Maximize the educational value of interventions by giving highest priority to business rules that the user has seen least often.
Escalate interventions to encourage compliance by giving higher priority to business rules which the user has violated the most.
Escalate an intervention to enforce compliance by removing the “Print” option from a modal dialog.
Avoid wasting end-users' time by suppressing business rules when the potential cost savings falls below a specified threshold.
Avoid excessive repetition of messaging by suppressing business rules to which the user has been exposed frequently within the recent past.

Such meta-level logic could be encoded within business rules, but would be repetitious and greatly complicate the logic. Using meta-rules enables one to define much simpler business rules, by layering the logic such that a condition (e.g. job cost exceeds a specified amount) can be defined just once, rather than within each business rule.

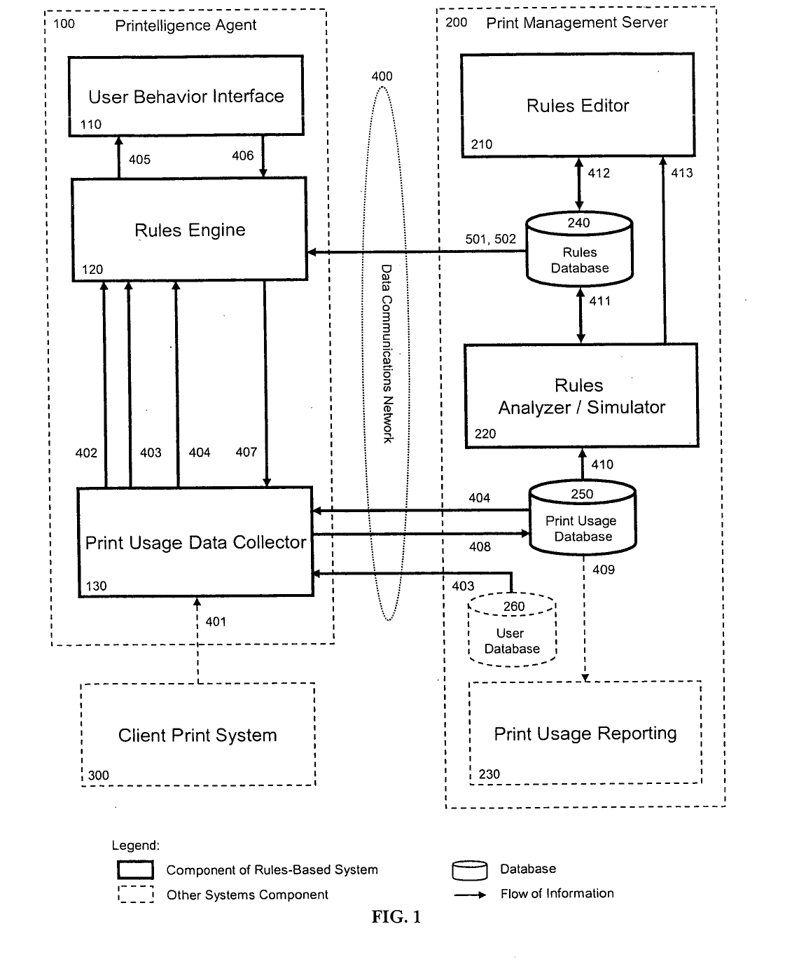

FIG. 1 illustrates one embodiment of the invention in the context of a print management system. In one embodiment, some components of the invention may reside on a client device as part of the client module software (100). Client devices may include desktop or laptop computers, or printers with processing capability and a user interface, which are connected to a local area network. Other components may reside on the print management server (200), which may be a centrally-hosted computer system. In one embodiment, the client-based components handle the monitoring and evaluation of individual print jobs, which are generated on client devices and typically sent to printers. The server-based components provide long-term storage of rules and print usage data, as well as management functions for the rules-based system. In one embodiment, the server communicates with clients over an Internet Protocol (IP) data network, such as a Local Area Network (LAN), a wide area network (WAN), a virtual private network (VPN) or the Internet.

Client-Based Components

In general, the components of the client agent (100): capture the specifications of every print job; evaluate business and meta-rules in the context of the print job, end-user profile and behavior history; interact with the end user to provide advice or direction related to the job; and record the user's response. All information related to each rule-processing transaction is uploaded to the print management server (200).

On the client device, the client agent (100) monitors the print queues on the client print system (300) for the arrival of new print jobs. When the agent (100) detects a new job, it notifies the print usage data collector (130), which queries the print queue for the print job's specifications, commonly called the “job jacket” (401).

The job jacket (401) includes such information as the number of copies and pages to be printed, whether the job is to be printed in color, and other details which may be pertinent. The print job jacket describes the document to be printed and the printer settings requested by the end-user. The job jacket corresponds to data structures created by the operating system. In one embodiment, the data collector gathers such information for every print job and transmits it (408) to the print management server for storage in the print usage database (250), even if the rules system is inactive.

If the rules system is activated on the client's device, the agent (100) instructs the client print system (300) to put the job on hold, and notifies the rules engine (120) that a new print job has been detected. The rules engine then queries the data collector for the job jacket. The data collector (130) enhances the standard operating system job jacket with other attributes of the document to be printed, such as keywords and phrases, and sends the enhanced job jacket (402) to the rules engine (120). The rules engine (120) also queries the data collector (130) for information about the user (403) and his or her past printing behavior, referred to herein as the user's “usage history” (404). The data collector (130) may obtain the user profile either from a data cache (not shown) on the client device or a user database (260) on the print management server (200). Similarly, the data collector (130) may obtain usage history from cache (not shown) or the print usage database (250).

In one embodiment, the rules engine (120) may require information that is not provided directly by the operating system. Data can be derived from information provided by the operating system or inspection of the print data stream (401). These data may be included in the extended job jacket that the data collector (130) provides to the rules engine (120).

The rules engine (120) then obtains the set of business rules (501) and meta-rules (502) currently in effect. The combination of rules (501) and meta-rules (502) is referred to herein as the “active ruleset”. The active ruleset may be obtained either from the local data cache or the rules database (240) on the server. The rules engine now has all the information required to evaluate business rules on the print job, in the context of the individual user's behavior history. In a process described in more detail below, the rules engine evaluates the business rules on the job jacket, user profile and usage history (collectively called the “print situation”), obtaining a set of candidate rules for execution. The rules engine then evaluates the meta-rules on this set of candidate rules and the situation, further filtering or prioritizing the candidate business rules. Finally, the rules engine selects one business rule to execute (or “fire”), by evaluating a final-selection meta-rule.

The rules engine (120) sends a description of the actions to be performed (405), as specified by the selected rule, to the user behavior interface (110). Actions may include displaying the job's cost, advising the user on more cost-effective alternatives, or requiring the user to enter a charge code or cancel and resubmit the job in a preferred configuration, or combinations of such actions. The behavior interface subsystem (110) generates the appropriate presentation to the end-user, which may be for example a popup balloon or a modal dialog, and prompts and records the user's response (406), which is sent back to the rules engine (120).

The rules engine (120) returns to the data collector (130) a complete record of all rules that matched the situation, which rule was fired, and how the user responded (407). The data collector forwards this record, together with the job jacket (408), to the print usage database, as an addition to print usage history. The data collector (130) may store a copy of this record in non-volatile memory on the client, which may be the same data cache referred to above.

Server-Based Components

As a result of inputs from the print usage data collector (130), the print usage database (250) acquires a historical record of print jobs, any business rules that applied to them, any interventions taken, and users' response thereto. This enables the print management system to build up a model of end-user behavior modification over time.

Information stored in the usage database (250) can be conveyed in the form of reports to administrators, business analysts and end-users through a print usage reporting module (230). Meta-rules can modify the action of a business rule such that the recommendation made by that rule is conveyed to the end-user through a routine (e.g. monthly) report, rather than immediately through the behavior interface.

Historical information from the print usage database (250) may also be utilized when creating or modifying rules. The rules editor (210) comprises user interfaces for describing the elements of a business or meta-rule, such as title, comments, conditions, and actions, and relations among rules, such as classes and priority levels. The editor (210) communicates rule specifications and relations (412) with the rules database (240).

In one embodiment, in order to validate rules before implementing them on client devices, the rules editor (210) may invoke a rules analyzer/simulator (220), which tests an individual business rule, or the application of a set of meta-rules to a business rule (411), in the context of historical data (410). The business rule is back-tested on a subset of print jobs recorded over history, to determine how many jobs it would match. If meta-rules are also tested on the business rule, they may be applied for each historical situation that matched it, to determine how often each meta-rule would match the business rule.

Once a rule or meta-rule has been created or modified, and preferably also back-tested, it can be activated for use on client devices. In one embodiment, the print management server (200) notifies clients (100) when new rules become available, so that they can be downloaded (501, 502) to the rules engine's cache in advance of need.

Steps of One Embodiment of a Method

Phase 1: Data Capture

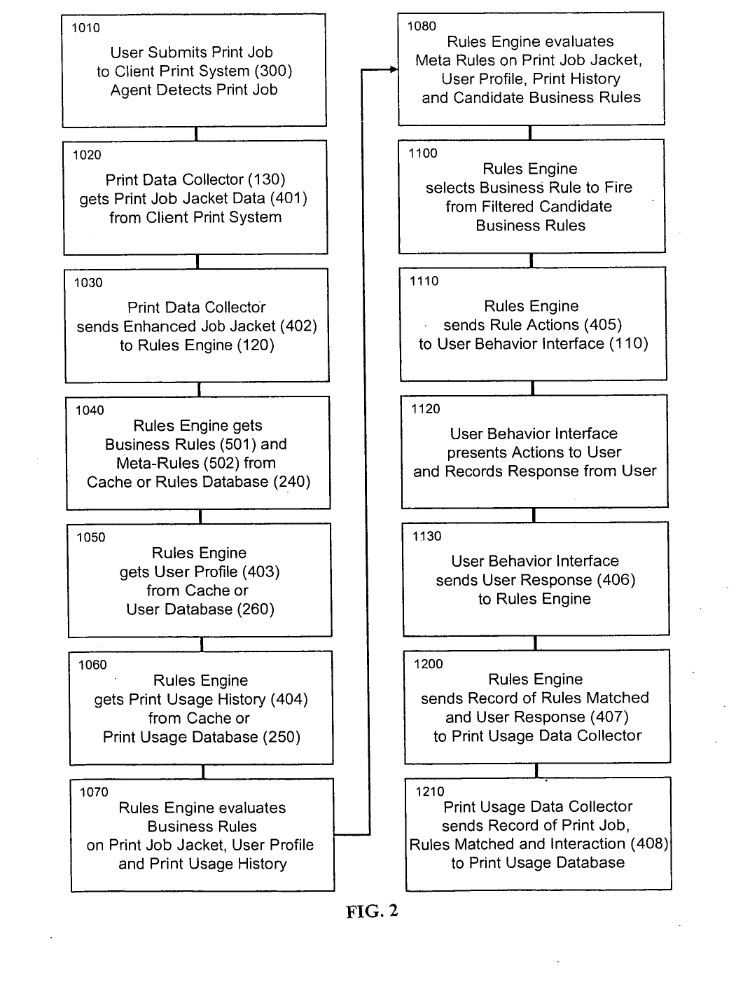

Referring to FIG. 2, a print job is queued to the local spooler in the client computer's print system (300), the system client agent (100) detects it (step 1010) and causes the spooler to put the job on hold. The agent (100) then invokes the print usage history data collector (130) to copy the print job jacket (401) from the print system and provide it (steps 1020, 1030) to the rules engine (120).

In one embodiment, the rules engine (120) examines not only the characteristics of the current print job in isolation, but also how it fits into patterns of the user behavior. To that end, the data collector (130) also collects historical data (404) concerning users and past print jobs, rules that matched those jobs, and the users' responses thereto.

To improve the efficiency of historical data access, in one embodiment, the data collector (130) may request only attributes of the user profile and print history actually referenced in the rules to be evaluated. Therefore, in one embodiment, the active ruleset is examined (step 1040) prior to fetching the user profile and print history. The required attributes are extracted from the business rules and meta-rules, including each attribute's name and selector arguments (e.g. the user ID), to construct a print usage database query.

The data collector obtains (step 1050) user profile information (415) either from the print agent's data cache on the end-user's computer, or from a user database (260), which may be external (e.g. a directory server), or stored within the print server (200).

The data collector (130) may obtain print history (404) either from client agent's data cache or a print usage database (230) on the print server (200), and may provide it to the rules engine (step 1060).

In one embodiment, the print history data (404) may include records for the current user, or a community of users, according to whether the active rule-set considers individual or collective behavior.

Phase 2—Business Rule Filtering

In the next phase (steps 1070 and 1080), the system progressively filters the initial set of business rules to select a final set of zero or more candidates, from which one rule may be selected for firing. If not business rule matches the condition, the print job continues without intervention from the system.

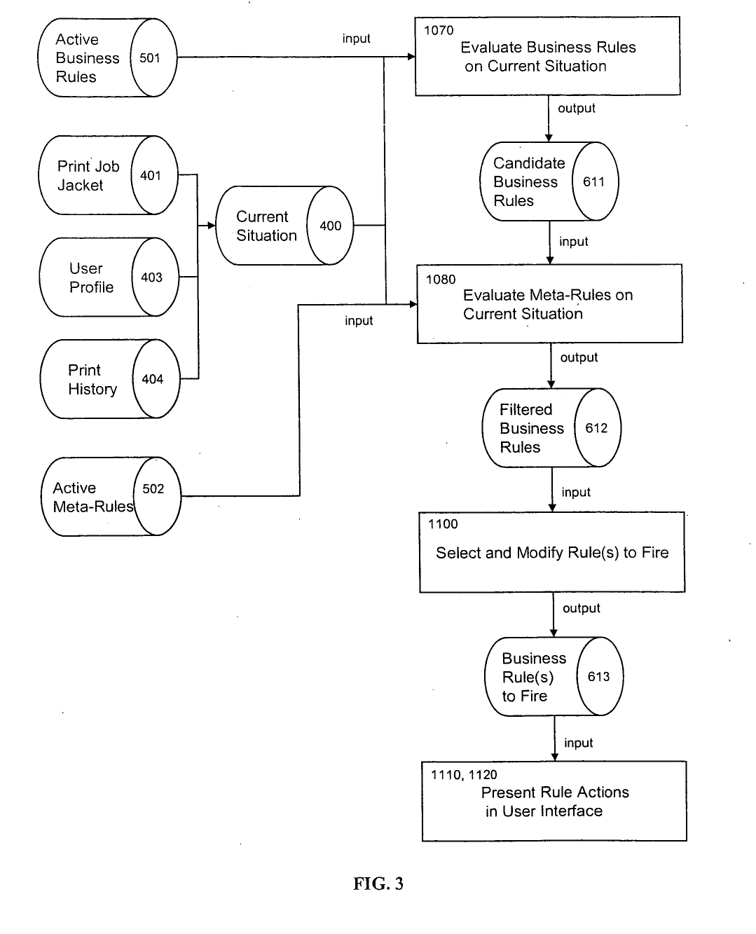

The rules engine now has the data concerning the current situation, which data may include the print job data, user profile and print history, and which are required for evaluating rules in that context (step 1070). FIG. 3 depicts an overview of the rules filtering process. To summarize the process, the ruleset evaluator reduces the input set of rules to a subset thereof which match the current situation, by filtering out rules that do not match. In one embodiment, a rule matches a situation only if all its conditional tests pass. Therefore, to filter out rules, the evaluator matches conditions until all pass or one fails.

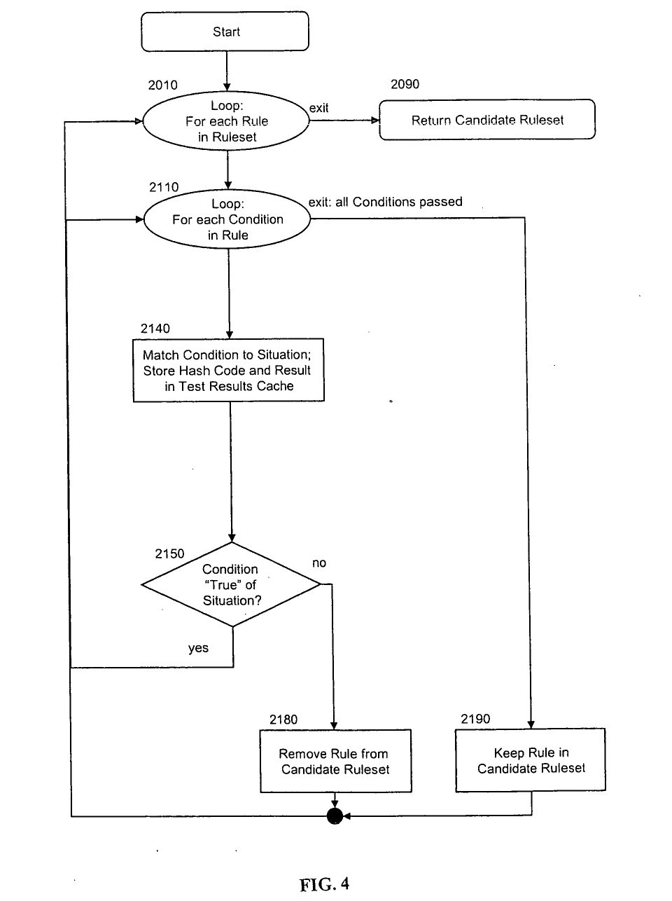

As shown in FIG. 4, the ruleset evaluator iterates over the set of business rules (step 2010). For each rule, the evaluator iterates over each condition in the rule (step 2110) until some condition does not match the current situation (step 2180). In one embodiment, for efficiency, the evaluator can be designed to avoid repeatedly testing conditions that appear in more than one rule. To that end, the evaluator calculates a hash code for the condition, using techniques well known to those skilled in the art (step 2120) and checks whether this code appears in the test results cache (step 2130). If not, the condition is matched to the current situation, and the hash code, business rule identifier, and match result (one of {True, False}) are stored as a triple in the cache (step 2140).

If the condition is marked as “True” in the cache (step 2150), the evaluator continues on to the next condition. If it is marked “False”, the rule is removed from the candidate ruleset (step 2180) and the evaluator proceeds to the next rule (step 2010). If the inner loop (step 2110) exits after all conditions have tested “True”, the rule is kept in the candidate ruleset (step 2190), to be input to the meta-rules evaluation process (step 1080).

Once all business rules have been tested, the outer loop (step 2010) exits with the filtered set of candidate rules which have matched the condition (step 2090).

Phase 3: Meta-Rules Matching

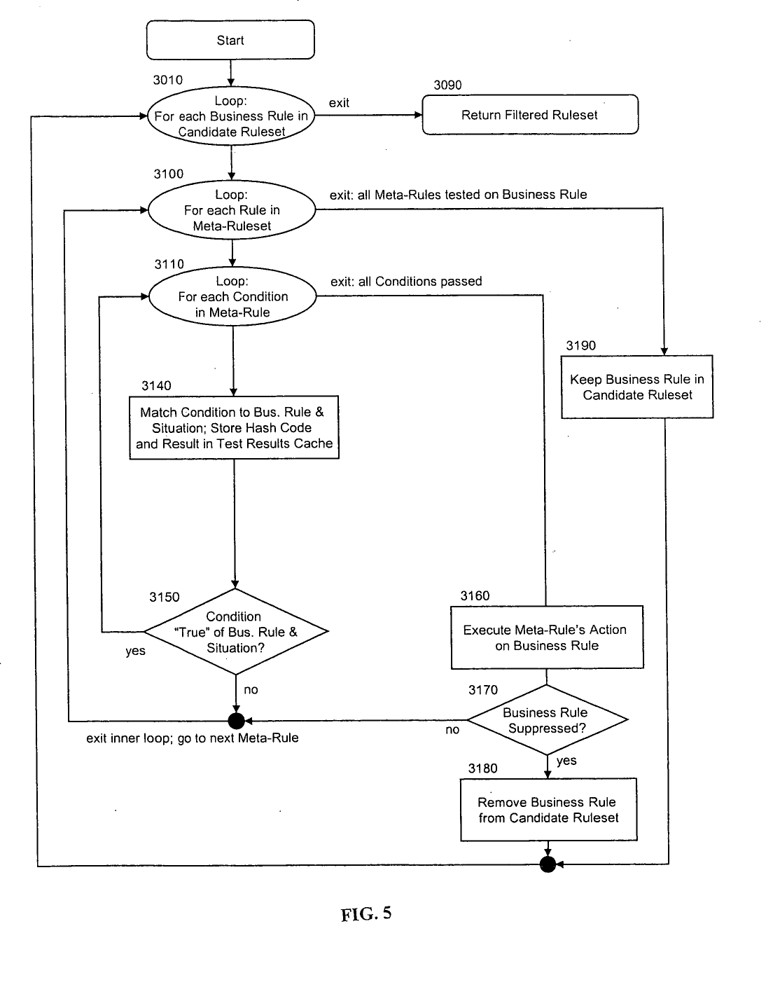

The candidate rules passed by the business rules evaluator are filtered a second time, by evaluating meta-rules (1080), as depicted schematically in FIG. 3. In one embodiment, this process may follow the algorithm depicted in FIG. 5. In one embodiment, the inputs to this process comprise the candidate ruleset (output from step 1070), the job jacket, user profile and print usage history, and the set of active meta-rules (502).

The filtering process iterates over the set of candidate business rules (611, step 3010), evaluating meta-rules on the current candidate business rule and a situation that comprises job jacket, user profile and print usage history. The filtering process identifies business rules that match some meta-rule in the current situation; when a match is found, the meta-rule's action is executed on that business rule. A typical meta-rule action is to suppress the business rule's action; when a business rule is thus suppressed, it is eliminated from the candidate ruleset such that it cannot be selected for execution (step 1100). Thus, the output of filtering through meta-rules is a set of zero or more business rules which are candidates for execution in the user interface.

To determine whether a business rule will remain in the candidate ruleset, the meta-rules evaluator iterates over meta-rules (step 3100), in a process similar to that used to test business rules. The inner loop of this process iterates over the conditions of each meta-rule (step 3110). In one embodiment, the evaluator calculates a hash code for each condition (step 3120) and checks whether it already appears in the test results cache (step 3130); if not, the evaluator matches the condition to the current business rule and situation, and caches the hash code, together with the business rule identifier and the result of matching (step 3140). The evaluator checks whether the condition is “True” of the current business rule and situation. If so (i.e. the condition “passes”), matching continues to the meta-rule's next condition; if not (i.e. the condition “fails”), then the meta-rule cannot match the current business rule and situation, and the evaluator proceeds to test the next meta-rule.

If all conditions pass, then the meta-rule does indeed apply to the current business rule and situation. In this case, the meta-rule's action is executed on the business rule (step 3160). As noted above, possible meta-rule actions include scheduling or suppressing the business rule's action. If the business rule's action is suppressed (step 3170), then the business rule is removed from the candidate ruleset (step 3180), and processing continues with the next business rule (step 3010). Otherwise, the current business rule is checked against the next meta-rule (step 3100); this implies that a business rule is suppressed if any meta-rule that would suppress it does indeed match it. As noted above, a meta-rule may modify a business rules's action without suppressing it; since more than one such meta-rule could match, some means of determining which modification to apply is required. In one embodiment of the present invention, only the modification associated with the highest-priority meta-rule would be applied.

If no meta-rule suppresses the business rule, it remains in the candidate ruleset (step 3190). Once all business rules have been checked, the process exits, outputting the filtered candidate ruleset (step 3090).

The meta-rules evaluator returns the filtered candidate ruleset, and the rules engine proceeds to select a business rules from this set to “fire”, that is, to execute in the user interface (step 1100). The decision at (step 1100) is governed by a special meta-rule that is applied only to the final set of candidate rules. Referred to as a “final selection meta-rule” it determines the conditions under which zero or 1 of the candidate business rules will fire. An example of a final selection meta-rule would be to “select the candidate rule having the highest priority.”

Phase 4: User Interaction

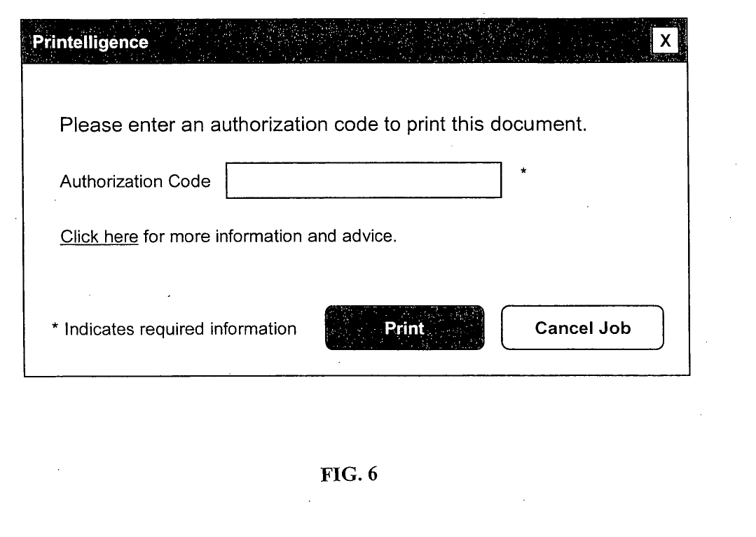

In one embodiment, the rules engine sends the selected rule to the user behavior interface for execution in the client computer's user interface (step 1110). The user behavior interface interprets the business rule action. The rule's action(s) are then executed in sequence. First, the print job is removed from the queue (if this was not done so already during rule processing) and put into a holding queue. Then the behavior interface generates a user interface dialog which might appear as in FIG. 6.

The user behavior interface presents the dialog to the end-user (step 1120), utilizing techniques built in to the client device's operating system. The user may then interact with the dialog in ways that are unpredictable. Program logic inserted for each user interface element by the behavior interface handles user interactions with the dialog.

Using the example of FIG. 6, if the user clicks the “X” (Close Window) or the Cancel Job button, the print job is canceled and a window appears briefly, containing the text “Print job canceled.” If the user clicks the Print button, without first having filled in the Authorization Code, a dialog pops up to explain that the user must fill in that field before proceeding. If the user clicks the “Click here” hyperlink, a new window appears, containing the help text for this business rule. If the user fills in the Authorization Code field (whether by inputting text or selecting it from a pull-down menu), the Print button becomes enabled.

If the user then presses Print, the user behavior interface sends the authorization code to the print server computer for validation, and a window appears, containing the text “Verifying authorization code; please stand by.” If the code fails verification, the text in that window changes to “Authorization code could not be verified; please retry.” The window then disappears and the user's cursor is placed in the Authorization Code field. If the code passes verification, the text changes to “Authorization succeeded; document sent to printer” and the print job is returned to the print queue.

Phase 5: Record of Results

The user behavior interface captures all end-user inputs to the user dialogs (step 1120). In particular, in one embodiment, it may record:

1. which data entry fields the user filled out, and whether such data passed any validation check that may have applied;
2. whether the user clicked on a help text hyperlink; and
3. which response button the user pressed to terminate the dialog.

Collecting users' inputs to each dialog enables the system to build statistics on dialog usage (e.g. how often users required help with a particular business rule) and on compliance with business rules, which statistics are utilized in meta-rules as described previously.

The following responses imply compliance with a business rule:

A) The user selects Cancel Job.
B) (Required data requested) The user fills in all required data fields and then selects Print.
C) (Optional, but not required, data requested) The user fills in zero or more of the optional data fields and then selects Print.

The following responses imply non-compliance:

D) (No optional or required data requested) The user selects Print.
E) (Required data requested) The user selects Print without filling in any required data field.
Note that case (E) can occur only if the dialog is configured such that the Print button is enabled before required data is entered.

The user behavior interface returns this record of the user's interaction to the rules engine (step 1130), which then bundles it with the list of all business rules and meta-rules that matched the situation related to this print job. The rules engine forwards this record of the rules matched, the rule fired, and the user's response, to the data collector (step 1200), which bundles it with the print job jacket and then forwards the completed record to the print management server, which translates the information into the form stored in the print usage database (step 1210) and updates running summary statistics such as the number of times each rule matched the user's print jobs, and the user's compliance rate with the rule that fired.

The print usage database (250) thus contains a complete record of: print job characteristics; the business and meta-rules that matched the job in the context of the individual user and his behavioral history; and the user's response to the print management system's attempt to modify his or her behavior.

Data Structures

Data structures such as would be utilized in one embodiment of the invention are exemplified below. As one skilled in the art would appreciate, data structure syntax could be designed in different manner without affecting functionality.

Individual print jobs, including the job configuration (called a “job jacket”), and optionally including characteristics of the printed document's content. In a typical embodiment of the invention, data as illustrated in Table JJSPEC are collected for each print job submitted through a computer on which the client is running. Data fields and types may vary from this example listing without limiting the relevance of claims related to this invention.

TABLE JJSPEC
Print Job Jacket Data Structure Specification in Typical Embodiment of Invention

| Field Code Name | Data Field Description and (Type) | Example Value |
|---|---|---|
| Collate | Collate □(enumeration: □0 = no, 1 = yes) | 0 = not collated |
| ColorDepth | Color depth in bits per pixel (integer) | 32 bits/pixel |
| ColorMode | Color printing mode (enumeration: | 2 = in color |
| | □Color = 2, Monochrome = 1) | |
| Copies | Number of copies to be printed (integer) | 3 copies |
| DocumentName | Filename of document to be printed (text) | Notepad - untitled.doc |
| Domain | Domain on which workstation resides | Gotacopy.preo.ca |
| | (text) | |
| DuplexMode | Duplexing mode □(enumeration: | 1 = single-sided |
| | □1 = single-sided print, □2 = double-sided, | |
| | flip along vertical edge, □3 = double- | |
| | sided, flip along horizontal edge) | |
| nUp | nUp: logical pages per physical page | 1 page per sheet |
| | (integer) | |
| Pages | Number of pages (integer) | 2 pages |
| PaperLength | Page length in mm (integer) | 240 mm |
| PaperOrientation | Orientation of print on paper | 1 = portrait |
| | □(enumeration: □portrait = 1, | |
| | landscape = 2) | |
| PaperTray | Paper size or index number of paper tray | 1 = letter size |
| | or bin □(enumeration: □letter = 1, | |
| | □legal = 5, etc □(there are about 45 sizes + custom)) | |
| PaperWidth | Page width in mm (integer) | 120 mm |
| PrinterDriver | Name of driver used by this printer (text) | HP LaserJet 1100 MS |
| PrinterName | Name of printer □(text, from system's | HP LaserJet 1100 |
| | list of Printers and Faxes) | |
| PrinterPort | Port to which printer is attached (symbol) | LPT2 |
| PrinterProcessor | Name of the print processor module in | WinPrint |
| | the subsystem □(text) | |
| PrintJobID | Unique Print Job Identifier □(sequential | 12B9929A77C7992FF |
| | integer) | |
| PrintQuality | Print quality □(enumeration: □1 = draft, | 3 = medium quality |
| | □2 = low, □3 = med, □4 = high) | |
| PrintResolution | Resolution in dots per inch (integer) | 600 dots per inch |
| Priority | Priority (integer 1 to 99) | 99 = highest priority |
| SpoolSize | Size of spool file in bytes □(integer) | 25634 bytes |
| TimeCompleted | Time job was completed □(date-time) | 2006:05:33 12:25 |
| TimeStarted | Time job was started □(date-time) | 2006:05:30 12:25 |
| TimeSubmitted | Time job was submitted (not yet started) | 2006:05:30 12:24 |
| | □(date-time) | |
| UserNotify | Username to receive notification when | vmullan |
| | printed □(text) | |
| UserSubmitted | Username requesting print □(text) | vmullan |
| Workstation | Workstation name (text) | CAL02 |

Among the data in Table JJSPEC, print job characteristics that affect the cost of a job typically include:
PrinterName (i.e. choice of printer)
Copies×Pages (affects amount of paper and toner/ink used)
PaperTray (i.e. choice of paper size and stock)
PaperWidth (affects cost of paper and potentially amount of toner/ink used)
PaperLength (same as for PaperWidth)
ColorMode (determines type of toner/ink used)
ColorCoverage (affects amount of color toner/ink used)
BlackCoverage (affects amount of black toner/ink used)
ColorPagesCount (may be used to determine click charges levied by print provider)
PrintQuality (affects amount of toner/ink used)
nUp (affects amount of paper used)
DuplexMode (affects amount of paper used)
Cost (calculated from unit costs associated with each job jacket characteristic listed above)
ChargeCode (may reduce cost by recovering it from a third party)

Optionally, the system may store a copy of the document content submitted for printing, or certain characteristics thereof. This is distinguished from the content of the document file, as the version printed may differ from the version saved as a file. Characteristics derived from the content include but are not limited to those listed in the Table ENHJJSPEC.

Business rules may implement policies related to security and document control. Such rules would test the aforementioned document characteristics against criteria to determine whether a print job should be flagged as suspicious, or requires authorization or re-routing to a secure printer. For example, a rule may test whether the file includes one of the key phrases {“secret”, “confidential”}, and if so, holds the job in queue until the user enters a valid authorization code.

The rules engine of the present invention may compare such characteristics of print jobs, as well as the computed cost (see Table ENHJJSPEC), to corresponding criteria in business rules.

The rules system may require information that is not provided directly by the operating system. Table ENHJJSPEC illustrates data that the system may derive from information provided by the operating system or inspection of the print data stream. These data may be included in the extended job jacket that the data collector provides to the rules system.

TABLE ENHJJSPEC
Enhancements to Print Job Jacket Specific to Printelligence Application

| Field Code Name | Data Field Description and (Type) | Example Value |
|---|---|---|
| AuthorizationCode | Code entered to authorize printing | B7TR5 |
| | (text) | |
| AuthorizingOfficer | Name of user who authorizes | jsmith |
| | printing this document (text) | |
| BlackCoverage | % of paper surface covered in black | 18% |
| | ink or toner: average for all pages in | |
| | job (floating point number) | |
| ChargeCode | Charge code (text) | F234-0567 |
| ColorCoverage | % of paper surface covered in color | 23% |
| | ink or toner: average for all pages in | |
| | job - 100% on a page is full bleed | |
| | □(floating point number) | |
| ColorPagesCount | Number of pages containing color | 2 pages |
| | ink or toner (integer) | |
| Cost | Cost of printing job, in system- | $2.34 |
| | defined currency (floating point | |
| | number) | |
| DocumentControl | Control of print event | 2 = authorization required |
| | □(enumeration: 0 = uncontrolled, | |
| | □1 = no print allowed, | |
| | □2 = authorization required to print, | |
| | □3 = notify officer of print event, | |
| | □4 = notify workflow system of print | |
| | event) | |
| DocumentType | File type or application name (text) | JPEG image |
| KeyPhrases | Content key phrases □(list of text) | “business plan”, |
| | | “confidential”, “share |
| | | offering” |
| PrinterLocation | Location of printer to which job is | Accounting.Canada.Edmonton. |
| | sent. | Bldg A.12.SE |
| | □(LocationStructure: □comprises | Accounting.*.*.*.* |
| | one or more of: □Organization, | (Accounting at any location) |
| | Country, City, Site, Floor, Section) | . . . Bldg A.12.* |
| | | (Organization, Country, City |
| | | not specified; any Zone) |

Some business and meta-rules refer to characteristics of the end-user: in particular, to the user's affiliation with organizational units. To enable measurement of organizational behavior, and target behavior modification interventions to organizational units or even to individuals, the system may maintain a record of individual user's system identity (user name), their association with organizational units or categories of usage (both of which are represented as “communities”). Table USERPRO depicts user information that may be provided to the rules system in one embodiment.

TABLE USERPRO
Information Concerning Individual Users

| Field Code Name | Data Field Description and (Type) | Example Value |
|---|---|---|
| UserName | Uniquely identifies the user within the | vmullan |
| | organization (UserID or Text) | |
| Communities | List of organizational units or print usage | {Product Development, |
| | profiles with which the user is | Marketing, Management, Calgary |
| | associated□(List of Text (community | Staff} |
| | names)) | |
| Location | The user's customary or current location of | Preo.Canada.Calgary.Bldg |
| | work□(LocationStructure - see definition in | A. Flr 24.SW |
| | Table ENHJJSPEC) | |

Business and meta-rules may refer to statistics about past printing behavior. To provide baseline measurements of print usage, and enable implementation of print quotas via business rules, the system may maintain records of individual users' cumulative volume and cost of printing over time. Table USAGEREC describes examples of these data.

These measures may be extracted relative to a specified time period, to facilitate reporting on print usage, and to enable the implementation of quota. For example, a business rule may test whether a user is approaching or has exceeded a quota on number of pages or total print cost in the current month or other time period.

To enable management to assess the effectiveness of business rules as instruments of policy, and to enable the rules system to adapt to individual behavior, the system may maintain a record of which rules matched each print job, any action taken by the system in consequence of rule matches, and the user's response, if any, to such action. As noted above, data collector provides this information to the print usage database. Data in Table USAGEREC related to rules matching and compliance may include (JobsMatchingRule) or (RuleComplianceRate).

The reporting subsystem may report statistical measurements of individual users' or organizational units' behavior, such as the percentage of print jobs that match a given rule, and the rate of compliance with that rule. Meta-rules may also check such statistics to decide how to prioritize a business rule for presentation to the user.

As with print usage statistics, these measures are extracted relative to a specified time period. This facilitates reporting on compliance with policies over time, and enables meta-rules to test for recent changes in behavior, as opposed to looking only at long-term cumulative averages. Note: throughout this disclosure, print usage and record of rule-based activity are collectively referred to a “behavior history”.

The print usage database develops such statistics from reports the data collector provides regarding individual print jobs, rules evaluation cycles and user responses to interventions.

TABLE USAGEREC
Printing Behavior History Statistics

| Element Name | Description and (Type) | Example Values |
|---|---|---|
| PrintJobs (User, TimePeriod) | Count (Integer) of print jobs | 4 print jobs submitted by vmullan |
| | submitted by the given user | today. |
| | (UserID) over the specified time | 36 print jobs submitted by |
| | period (TimeIntervalSpecifier) | vmullan month-to-date. |
| PrintedPages (User, | Total number of pages (Integer) in | 20 pages printed in the 4 print jobs |
| TimePeriod) | print jobs submitted by the given | submitted by vmullan today. |
| | user (UserID) over the specified | 300 pages printed in the 36 print |
| | time period | jobs submitted by vmullan month- |
| | (TimeIntervalSpecifier) | to-date. |
| CumulativePrintCost (User, | Total cost (Currency Amount) of | $1.60 for the 4 print jobs |
| TimePeriod) | print jobs submitted by the given | submitted by vmullan today. |
| | user (UserID) over the specified | $66.00 for the 36 print jobs |
| | time period | submitted by vmullan month-to- |
| | (TimeIntervalSpecifier) | date. |
| JobsMatchingRule (User, | Count (Integer) and percentage | 2 (50% of) print jobs submitted by |
| TimePeriod, RuleID) | (Rational) of print jobs submitted | vmullan today matched rule BR- |
| | by the given user (UserID) over | 601. |
| | the specified time period | 12 (33% of) print jobs submitted |
| | (TimeIntervalSpecifier) that | by vmullan month-to-date |
| | matched the given business rule | matched rule BR-601. |
| | (RuleID) | 220 (40% of) all print jobs |
| | | submitted by vmullan matched |
| | | rule BR-601, since it was |
| | | implemented (AllHistory). |
| RuleComplianceRate (User, | Count (Integer) and percentage | User vmullan complied with rule |
| TimePeriod, RuleID) | (Rational) of occasions on which | BR-601 on 1 occasion today (50% |
| | the user (UserID) complied with | of the times it was presented). |
| | the given rule (RuleID) when it | Since rule BR-601 was first |
| | was presented to the user, over the | implemented, user vmullan |
| | specified time period | complied with it on 196 (80% of) |
| | (TimeIntervalSpecifier) | the occasions it was presented to |
| | | him. |

In the above table, (UserID) is a symbol or text string that uniquely identifies the user. (TimeIntervalSpecifier) is one of {Today, MonthToDate, YearToDate, AllHistory} or a date range comprising start and end dates (e.g. Start=YYYY MM DD, End=YYYY MM DD). (RuleID) is a number or symbol that uniquely identifies a rule in a database of rules.

The business rules of the present invention may take the form of a conditions:actions pair, as used commonly in rules-based systems. The condition part specifies one or more criteria to be tested on the print job, the user's profile and the usage and behavior history. All conditions must match for the rule to match the situation (i.e. conditions are conjoined rather than disjoined). The action part specifies one or more functions to be performed when the rule is selected for execution.

For example, consider a rule to limit the cost of color printing through a soft quota that specifies the conditions:

If the job cost exceeds $5.00

and the user is a member of the Developer community

and the user's cumulative cost of print for the current month exceeds $100.00

and the job is in color

If all these conditions match the current situation, the rule is a candidate for execution (subject to the influence of meta-rules). Assuming it is selected for firing, this rule would execute the following actions:
Put the print job on hold.
Display a modal dialog showing the cost of the job and advising the user that “You have exceeded your monthly print allowance. Please charge this job to an account or resubmit it in black & white.”.
Require the user to enter a charge code or resubmit the job in black & white

In one embodiment of the invention, each conditional test is represented as an (attribute, operator, value) triple, as shown in Table BRCOND. The attribute names some observed characteristic of print job, user profile or behavior history (collectively, the “situation”). Attributes may be any of several data types:
Numerical (integer or rational): e.g. cost, number of pages
Boolean (True, False): e.g. job is duplexed
Text string: e.g. the keyword “confidential”
Identifier for object or structure: e.g. the Executive user community, the location Accounting.Canada.Calgary.BldgA.24.SW
Enumerated set of symbols (also called “enum”): e.g. color modes {monochrome, grayscale, color})
List of any of the other attribute types: e.g. a list of user communities.

The value specifies a pattern to which this observation is compared; the value could be a singleton (e.g. a cost of $2.00) or a collection (e.g. a list of keywords {“business plan”, “confidential”, “proprietary”}).

The operator specifies how the attribute in the situation is to be compared with the criterion value. Commonly used operators for the various types of attributes are listed below:
Numerical attribute comparison: <, <=, =, >=, > and < > (not equal)
Boolean attribute test: =
Text string comparison: =, < >, contains (the criterion value is a substring of the observed value), does not contain, is contained in (the observed value is a substring of the criterion), is not contained in, approximately matches (a heuristic match)
Enumerated set membership: =, < > (where the criterion is a single value from the enum), is one of (the observed value matches one of the values in the set), is not among
Identifier or structure match: =, < > (the observed value is compared to the structure as a whole), is part of (the observed value matches a portion of the structure), is not part of
List membership tests: is (observed attribute includes the entire set), is one of (the observed value appears in the list), is not among (the observed value does not appear in the list), includes (the observed value includes the given item), includes one or more of (the observed value includes one or more of the items in the list)

For generality, a rule's condition part may be empty, in which case the rule is deemed to match any situation.

In one embodiment, business rule conditions take the form of (Attribute, Operator, Value) triples. Table BRCOND illustrates the form and semantics of such triples as would be utilized in one embodiment of the invention. For exemplary definitions of the attributes, refer to Tables JJSPEC, USERPRO and USAGEREC in the examples below.

TABLE BRCOND
Business Rule Conditions in a Typical Embodiment of the Invention

| Attribute/Usage | Applicable Operators | Value Type or Range |
|---|---|---|
| JobJacket.ChargeCode | is (matches a specific code) | List of Text (charge codes) |
| Check whether job is charged to one of a | is one of (matches one of the | |
| list of account codes specified by the rule. | codes in the list: most | |
| | commonly used operator) | |
| | is not among (the job jacket | |
| | code does not appear in the | |
| | list) | |
| | contains (code contains the | |
| | text in the value) | |
| | is not empty | |
| JobJacket.ColorMode | = | Enum (color mode specifier) |
| Check whether job is in color. | [symbol] (not equal) | |
| JobJacket.Copies | <, <=, =, >=, > | Integer |
| Compare number of copies printed to | Most commonly used is > | |
| number of copies specified by rule. | (exceeds) | |
| JobJacket.Cost | <, <=, =, >=, > | Currency Amount |
| Compare print job cost to some limit | Most commonly used is > | |
| specified by rule. | (exceeds) | |
| JobJacket.DocumentType | is (matches a specific | List of Text (document or file |
| Check whether the type of document to be | document type) | type specifiers) |
| printed is covered by the rule. | is one of (matches one of the | |
| | types in the list) | |
| | is not among (the document | |
| | type in the job jacket type | |
| | does not appear in the list) | |
| | contains (the document type | |
| | name contains the text in the | |
| | value) | |
| JobJacket.DuplexMode | = | Boolean (True: job is |
| Check whether job is printed in duplex. | [symbol] | duplexed; False: job is |
| | | single-sided) |
| JobJacket.KeyPhrases | includes one or more of | List of Text (key phrases) |
| Check whether the document to be printed | partially matches one or more | |
| contains key words or phrases specified by | of | |
| the rule. | | |
| JobJacket.nUp | <, <=, =, >=, > | Integer |
| Check whether job is printed n-Up. | Number of document pages | |
| | mapped to a single physical | |
| | page. | |
| | Most commonly used is > | |
| JobJacket.Pages | <, <=, =, >=, > | Integer |
| Compare number of pages printed to | Most commonly used is > | |
| number of pages specified by rule. | (exceeds) | |
| JobJacket.PaperTray | is (matches a specific tray | List of Text (paper tray |
| Check whether paper tray selected for print | name) | names) |
| job matches tray specified by rule. | is one of (matches one of the | |
| | tray names in the list) | |
| | is not among (the job jacket | |
| | tray does not appear in the | |
| | list) | |
| | contains (tray name contains | |
| | the text in the value) | |
| JobJacket.PrinterLocation | is one of (matches one of the | List of Locations |
| Check whether the print job is to be routed | locations in the list) | |
| to a printer governed by the rule. | is not among (the locations in | |
| | the list) | |
| UsageHistory.CumulativePrintCost | <, <=, =, >=, > | Currency amount |
| (User, TimePeriod) | Most commonly used is > | |
| Check whether the user has exceeded a | (exceeds) | |
| quota on print spending over the specified | | |
| time period. | | |
| UsageHistory.PrintedPages (User, | <, <=, =, >=, > | Integer count of pages |
| TimePeriod) | Most commonly used is > | |
| Check whether the user has exceeded a | (exceeds) | |
| quota on number of pages printed over the | | |
| specified time period. | | |
| UserProfile.Communities | includes one or more of (the | List of Text (community |
| Check whether the user belongs to one or | communities in the list) | names) |
| more communities to which the rule | does not include (any of the | |
| applies. | communities in the list) | |

The examples of conditional tests given above under “General Form of Business Rules” could be represented as shown in Table FRMLCOND, which shows how descriptions of business rule conditions in English correspond to a possible formal representation as (Attribute, Operator, Value) triples.

TABLE FRMLCOND
Example of Formal Representation of Business Rule Condition
Expressions

| English Description | Formal Representation |
|---|---|
| Job cost exceeds $5.00 | (JobJacket.Cost, >, $0.50) |
| User is a member of the Developer | (UserProfile.Communities, includes, |
| community | {“Developer”}) |
| User's cumulative cost of print for | (UsageHistory.CumulativePrintCost |
| the current month exceeds $100.00 | (User, MonthToDate), >, $100.00) |
| Job is in color | (JobJacket.ColorMode, =, InColor) |

Actions

The action part of a rule specifies a list of one or more functions and their parameters, to be executed on the client device or print management server as appropriate. A function may modify the state of the system, or present a user interface dialog, or populate components of such a dialog. Functions defined in the system rules language may include those appearing in table BRACTIONS.

Conceptually, the action performed by a business rule comprises an interaction with the end user, implemented through some form of dialog, and the user's response as expressed through input to the dialog. User interaction dialogs may be constructed from the elements listed in Table BRACTIONS below.

TABLE BRACTIONS
Specification of Business Rule Actions to be Performed in User
Interface

| Element | Description (Type) | Examples |
|---|---|---|
| Message | (Text) presented to user, to describe | “To reduce the cost of printing, please |
| | the action recommended by the | re-submit this job in black & white.” |
| | business rule. | |
| Help_Text | Additional (Text) presented at the | “Printing in color costs $0.50 per page, |
| | user's request, to further explain the | whereas black & white costs $0.08. To |
| | business rule and/or recommended | change the job to black & white, click |
| | action. | Preferences in the Print dialog, and then |
| | | select Black & White or Monochrome.” |
| Show_Job_Cost | Indicates whether the cost of the | “This job will cost $4.80. To reduce the |
| | print job will be included in the | cost of printing, please re-submit this |
| | dialog. | job in black & white.” |
| | (One of {True, False}) | |
| Schedule | Indicates when the interaction with | A meta-rule may reschedule an |
| | the user will occur. | “Immediate” interaction for the |
| | An (Enum), one of: | “Next_Report”, e.g. to avoid |
| | Immediate: As soon as the rule is | interrupting the user while working. |
| | executed; always used when | |
| | interrupting a print job to get | |
| | information or confirmation from the | |
| | user. | |
| | Next_Report: Message will be | |
| | included in the next scheduled report | |
| | sent to the user according. | |
| Print_Job_Queue | Indicates what is to be done with the | A business rule that simply informs the |
| | print job, pending interaction with | user of what the job cost would be |
| | the user. | configured “Job_Proceeds”. |
| | An (Enum), one of: | A business rule that requires the user to |
| | Job_Proceeds: let the job go to the | enter a charge code would be |
| | printer asynchronously with any | configured “Pause_Print_Job”. |
| | interaction; used when the purpose of | A business rule that advises the user to |
| | interaction is merely to inform the | re-submit the job in a less costly |
| | user. | configuration (e.g. black & white vs |
| | Pause_Print_Job: hold the job in | color), but allows the user to override, |
| | queue until the user responds to the | would be configured |
| | request for interaction. | “Pause_Print_Job”. |
| | Cancel_Print_Job: delete the job | A business rule that disallows printing |
| | from the queue, e.g. because the given | in color would be configured |
| | job configuration is not permitted. | “Cancel_Print_Job”. |
| Dialog_Type | Indicates the form of interaction | “This print job cost $4.50” Message |
| | presented to the user. | displayed in a pop-up balloon. |
| | An (Enum), one of: | “This print job will cost $22.00. Please |
| | Balloon: The message is displayed | either re-submit it in black & white, or |
| | briefly in a window that does not | enter an account code or reason for |
| | require the user to interact with it. The | printing it.” Message displayed in a |
| | window will fade out automatically if | modal dialog that includes data entry |
| | the user does not dismiss it. Typically | fields for account code and reason, and |
| | used with Print_Job_Queue = “Job_Proceeds”. | buttons “Print” and “Cancel Job”. |
| | Modal: The message and possibly | |
| | buttons and data entry fields are | |
| | displayed in a dialog that requires the | |
| | user to interact. The user must dismiss | |
| | the window by clicking one of its | |
| | Response_Buttons. Typically used | |
| | with Print_Job_Queue = “Pause_Print_Job” | |
| | or | |
| | “Cancel_Print_Job”. | |
| Data_Entry | A set of data that the user may be | “To save costs, you should re-submit |
| | asked to enter to complete | this job in black & white. If you must |
| | interaction with the business rule. | print in color, please enter the reason |
| | The behavior interface generates a data | below.” |
| | entry fields in the dialog for each item | (Reason_for_Printing: Mode = Required) |
| | in the Data_Entry list. | “To recover the cost of printing, please |
| | A list of typed DataFields, including: | enter a charge code below.” |
| | Reason_for_Printing (Text): the user | (Charge_Code: Mode = Optional) |
| | enters an explanation for overriding | “This is a secure document. You must |
| | the business rule. | enter an authorization code before |
| | Charge_Code (Text or | proceeding to |
| | AccountCode): the user enters or | print.”□(Authorization_Code: Mode = Required) |
| | selects an account to which the job is | |
| | charged. | |
| | Authorization_Code (Text): the user | |
| | enters a code to authorize release of | |
| | the print job. | |
| | A data entry field has a mode attribute, | |
| | indicating whether the information is | |
| | required or optional. | |
| | Mode is an (Enum), one of: | |
| | Required: The user must enter the | |
| | requested information before the print | |
| | job can proceed. | |
| | Optional: The user can continue the | |
| | print job without entering the | |
| | requested information. | |
| User_Responses | User-interactions that complete the | “To recover the cost of printing, please |
| | dialog and finally determine | enter a charge code below.” |
| | disposition of the print job. These | The dialog appears with Print and |
| | interactions are typically implemented | Cancel Job buttons. The Print button is |
| | as buttons, and are used only with | disabled until the user enters a charge |
| | Modal_Dialogs. | code. |
| | An (Enum), one of: | “You have exceeded your monthly print |
| | Print: Send the job to the printer. | quota. Please contact your administrator |
| | Typically, this button is not presented | to extend your quota.”□The dialog |
| | if Print_Job_Queue = Cancel_Print_Job. | appears with only a Cancel Job button. |
| | Typically, this | |
| | button is enabled only if the user has | |
| | filled in all Data_Entry items marked | |
| | “Required”. | |
| | Cancel_Job: Delete the print job from | |
| | the queue. | |

If a rule specifies functions that involve interaction with the end-user, the user behavior interface (110) executes those functions on the client device, interfacing to and utilizing the device's operating system. The behavior interface generates a dialog that includes each element specified in the rule's action block.

In one embodiment of the invention, actions could be represented in the eXtensible Markup Language (XML), as illustrated in Table FRMLACT, which illustrates how business rule actions described in English might be translated into a dialect of the XML.

TABLE FRMLACT
Example of Formal Representation of Business Rule Actions

| English Description | Formal Representation |
|---|---|
| (Start of action block) | <Action> |
| Put the print job on hold | Print_Job_Queue = “Pause_Print_Job” |
| Display a modal dialog . . . | <User_Dialog> |
| | Dialog_Type = “Modal” |
| Showing the cost of the job | Show_Job_Cost = “True” |
| Advising the user that they have | Message = “You have exceeded your monthly print |
| exceeded their monthly print | allowance. Please charge this job to an account or resubmit it |
| allowance | in black & white.” |
| Requiring the user to enter a | <Data_Entry> |
| charge code . . . | <Charge_Code Usage = “Required”/> |
| | <Data_Entry> |
| . . . or resubmit the job in black & | <User_Responses> |
| white | <Print EnableIf = “Required_Data_Entered/> |
| | <Cancel_Job Focus = “Default”/> |
| | </User_Responses> |
| (End of modal dialog) | <User_Dialog> |
| (End of action block) | </Action> |

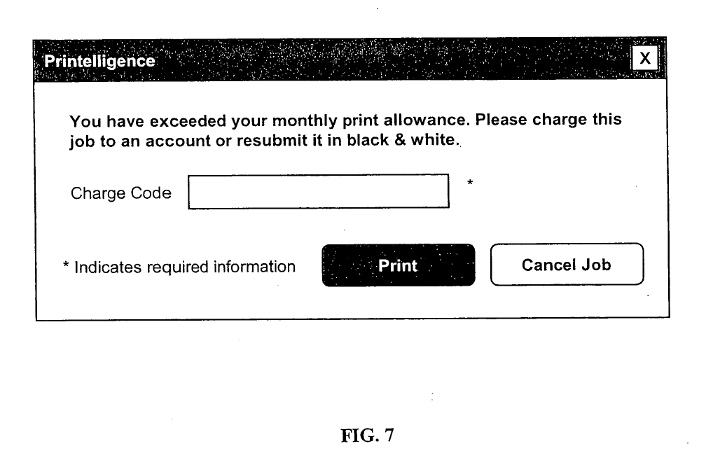

In one embodiment, The modal dialog generated according to the XML specification above could appear as in FIG. 7.

Relations Language

To facilitate comparisons among business rules, in one embodiment, the invention may comprise representations of relations among them: in particular, grouping of rules into classes, and priority ordering of individual rules or classes.

A class represents some equivalence relation among a set of rules, such that meta-rules could refer to the class in order to treat all member rules similarly. A common use of the class construct is to group rules by function related to organizational policy. For example, one might define classes such as: Cost Control, Cost Recovery, Green Initiative, and Security. Rules would be assigned to classes according to the policies they are intended to implement. Since classes are defined as a relation, it is possible to assign a rule to more than one class.

Formally, a class is defined as a relation between a class name and a set of business rules. A priority relation specifies a partial ordering of business rules or classes, such that rules appearing closer to the front of the list (or whose class is closer to the front) would be selected in preference to those appearing further back, given no other selection criteria. Rules or classes may be indicated to have the same priority level, using special notation.

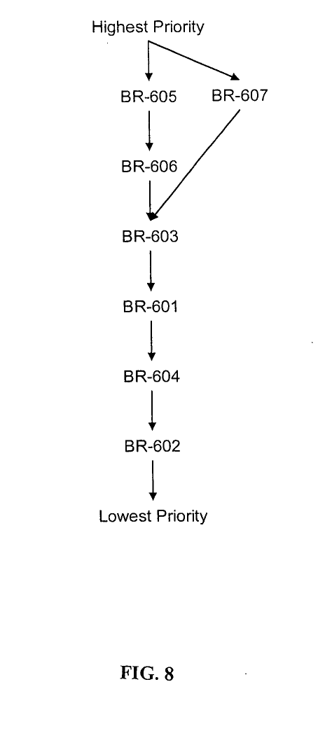

A given instance of the rules based system may specify more than one priority relation; each is evaluated independently, but any implicit ordering across the relations due to common references to rules or classes can be computed by constructing the complete lattice of the partial order from all relations, as exemplified in FIG. 8. This construction is useful because it also identifies conflicts among relations, i.e. where implicit ordering produces a cycle in the lattice.

One embodiment of the invention could represent class and priority relations as depicted in Table FRMLREL, which describes the relations defined among collections of business rules in a typical embodiment of the invention. Example relations are those defined for the business rules in the examples below.

TABLE FRMLREL
Formal Specification of Relations Among Business Rules

| Relation Syntax/Types | Description | Examples |
|---|---|---|
| Class (Name, Members) | Business rules listed in | Class (Cost_Reduction, {BR-601, BR- |
| Name is an identifier (e.g. text | Members belong to the | 603, BR-604}) |
| string). | group (class) indicated by | Class (Cost_Recovery, {BR-601} |
| Members is a set of Business | Name. | Class (Green_Initiative, {BR-602}) |
| Rules. | | Class (Security, {BR-605, BR-606, BR- |
| | | 607}) |
| Priority (Candidates) | Business rules or classes in | Priority (Security, Cost_Recovery, |
| Candidates is an ordered list of | the Candidates list are | Cost_Reduction, Green_Initiative) |
| Business Rules or Classes. | ordered such that those | Priority (BR-605, BR-606) |
| | closer to the front of the list | Priority (BR-603, BR-601) |
| | have higher priority. | |

Meta-Rules Language

Meta-rules take the same general condition:action form as business rules. As in business rules, the condition part comprises multiple (attribute, operator, value) tests, all of which must pass for the meta-rule to fire. The action part similarly comprises a list of one or more functions to be executed.

For example, consider a meta-rule intended to avoid presenting interventions with which the user generally complies (thus allowing the user an occasional exemption). Suppose that the policy is to exempt the user from a cost-control measure, provided the job is not extremely expensive. Suppose also that there can be no exemption from security restrictions.

The meta-rule could be specified as follows:

If the business rule is for cost-control or a green initiative

and the user complies with the business rule at least 90% of the time

and the job costs less than $10.00

Then record that the business rule was matched

but suppress the rule's actions

Thus, if the user submitted a print job that cost $5.00, no cost-control or green initiative rule would fire unless the user's history record shows a long-term compliance rate below 90%. By default, any security rule that matched would remain a candidate for firing.

Meta-rules conditions may include any of the attributes listed in Table BRCOND above for business rules, as well as the attributes and relations given in Table MRCOND below.

TABLE MRCOND
Meta-Rule Conditions in a One Embodiment of the Invention

| | Applicable | Value Type or |
|---|---|---|
| Attribute or Relation/Usage | Operators | Range |
| UsageHistory.JobsMatchingRule (User, TimePeriod, | <, <=, =, >=, > | Number or |
| RuleID) | Most commonly | Percentage |
| Find out how many of the user's print jobs over the specified | used are <, > | |
| time period matched the given business rule (RuleID), and | | |
| compare to a threshold in the meta-rule. | | |
| UsageHistory.RuleComplianceRate (User, TimePeriod, | <, <=, =, >=, > | Number or |
| RuleID) | Most commonly | Percentage |
| Find out how often the user complied with the given business | used are <, > | |
| rule (RuleID) over the specified time period, and compare to a | | |
| threshold in the meta-rule. | | |
| UsageHistory.PrintJobs (User, TimePeriod) | <, <=, =, >=, > | Integer |
| Compare the number of print jobs the user submitted during | Most commonly | |
| the specified time period against a threshold in the meta-rule. | used are <, > | |
| UsageHistory.PrintedPages (User, TimePeriod) | <, <=, =, >=, > | Integer |
| Compare the number of pages the user printed during the | Most commonly | |
| specified time period against a threshold in the meta-rule. | used are <, > | |
| UsageHistory.CumulativePrintCost (User, TimePeriod) | <, <=, =, >=, > | Currency Amount |
| Compare the total cost of the user's print jobs during the | Most commonly | |
| specified time period against a threshold in the meta-rule. | used are <, > | |
| BusinessRule.Action.IsMandatory ( ) | = | {True, False} |
| Tests whether the business rule's either requires the user to | | |
| cancel the job or enter a mandatory input (e.g. a charge code) | | |
| from the user for the job to proceed. | | |
| Relations.Class (ListOfClasses) | includes, does not | Rule |
| Test whether the given business rule is a member of the | include | |
| specified class(es) of rules. | | |
| Relations.Priority | select highest of | List of Rules |
| Given a list of candidate business rules, determine which | | |
| one(s) has/have the highest priority in the set of priority | | |
| relations over rules or rule classes. | | |

The examples of conditional tests given above under “General Form of Meta-Rules” could be represented as shown in Table FRMLCONDMETA, which illustrates how descriptions of meta-rule conditions in English correspond to a possible formal representation as (Attribute, Operator, Value) triples.

TABLE FRMLCONDMETA
Example of Formal Representation of Meta-Rule Conditions

| English Description | Formal Representation |
|---|---|
| Business rule is for cost-control | Relations.Class (“Cost Control”, |
| or a green initiative | “Green Initiative”) include |
| | CurrentBusinessRule |
| User complies with the business | UsageHistory.RuleComplianceRate |
| rule at least 90% of the time | (User, AllHistory, |
| | CurrentBusinessRule) >= 90% |
| Job costs less than $10.00 | JobJacket.Cost < $10.00 |

As in business rules, meta-rules can test any attribute of the print job jacket, user profile or usage history. Since meta-rules concern the selection and prioritization of business rules, they tend to test attributes of usage history, in particular those concerning cumulative print usage and business rule compliance. Meta-rules may also test attributes of business rules, such as their priority or membership in a class of rules. Various types of functions that might be executed by meta-rules are listed in Table MRACTIONS.

However, in contrast to business rules, meta-rule actions do not construct end-user dialogs, but rather act upon business rules, potentially suppressing them, changing their priority, or modifying functions. Within the scope of the invention, a meta-rule could modify any aspect of a business rule's action: considering this in terms of an XML representation of actions, the meta-rule could add or remove tags, or change properties of tags. In a typical embodiment of the invention, however, adaptive behaviors of the sort noted in the introduction to meta-rules could be achieved through suppressing or re-prioritizing business rules. Any changes a meta-rule makes to priority or class relations are only temporary, i.e. for the duration of the processing and execution of rules in context of the current print job.

Table MRACTION illustrates a formal representation of the example actions. A meta-rule's action part comprises one or more functions to be performed on the current business rule. Table MRACTION depicts the syntax and semantics of such functions in a typical embodiment of the invention. Note that some functions temporarily modify relations among business rules: such modifications are in effect only during processing of meta-rules for the current print job. Other functions temporarily modify the user dialog to be generated by a business rule: such modifications are in effect only for execution of the dialog in response to the current print job.

TABLE MRACTION
Specification of Meta-Rule Actions to be Executed on Business Rules

| Function | Description |
|---|---|
| BusinessRule.Record_Match (True) | Ensure the system records that this rule was matched. |
| BusinessRule.Take_Action (False) | Prevent the business rule from firing; note in the history of |
| | rule matching that the business rule was suppressed by the |
| | given meta-rule. |
| BusinessRule.Schedule_Action (Occasion) | Reschedule the business rule's action for execution. |
| | Occasion is one of {Immediate, NextRoutineReport} |
| Temp_Reprioritize (PrioritiesRelation, | Temporarily modify the given priorities list. |
| NewPrioritiesList) | This can have the effect of placing the current business |
| | rule higher or lower in priority among other candidates for |
| | firing. |
| Temp_Add_to_Class (BusinessRule, Class) | Temporarily add the business rule to the specified class if |
| | it is not already a member thereof. Class may be pre- |
| | existing or created ad hoc. |
| | This can have the effect of re-prioritizing a rule or |
| | modifying the evaluation of subsequent meta-rules. |
| Temp_Remove_Class (BusinessRule, Class) | Temporarily remove the business rule from the specified |
| | class if it is a member thereof. |
| | This can have the effect of re-prioritizing a rule or |
| | modifying the evaluation of subsequent meta-rules. |
| BusinessRule.Action.Add_Element | Temporarily adds an element to a dialog if not already |
| (ElementType, LogicIndicator) | included therein. |
| ElementType specifies some defined | |
| information, data entry field or button, such as | |
| Job_Cost, Charge_Code, Print_Button, etc. | |
| LogicIndicator specifies whether a data element | |
| is Informational (no user input), Optional (user | |
| need not fill it in to print), or Required (user | |
| must fill in for job to proceed), or whether a | |
| button is in focus by default. | |
| BusinessRule.Action.Remove_Element | Temporarily removes the specified element from a dialog |
| (FieldType) | if present therein. |

The algorithm for selecting business rules to fire (see “Phase 3: Meta-Rules Matching”) automatically removes a business rule from the set of candidates for firing when Take_Action is set to False.

### EXAMPLES

The following examples are intended to illustrate the claimed invention and not be limiting in any manner. As mentioned above, when the agent on a client device detects a new print job, it invokes the rules system to determine which business rules match the current situation, and which, if any, should be acted upon. The process of matching and selecting business rules is described in detail here with a worked example.

### Example 1

### Print History Data

For this example, the relevant subset of print history data is illustrated in Table HPR. In this example, the print history consists of daily summary statistics concerning print jobs submitted by user vmullan, and rules matched by those jobs. The table below illustrates a subset of such history data.

TABLE HPR
Example History of Print Jobs and Rules Evaluation

| Date | Parameter Name | Value |
|---|---|---|
| 2006 05 30 | PrintJobs (User = vmullan, | 6 jobs |
| | TimePeriod = Today) | |
| 2006 05 30 | PrintJobs (User = vmullan, | 52 jobs |
| | TimePeriod = MonthToDate) | |
| 2006 05 30 | PrintJobs (User = vmullan, | 227 jobs |
| | TimePeriod = YearToDate) | |
| 2006 05 30 | PrintedPages (User = vmullan, | 22 pages |
| | TimePeriod = Today) | |
| 2006 05 30 | PrintedPages (User = vmullan, | 472 pages |
| | TimePeriod = MonthToDate) | |
| 2006 05 30 | PrintedPages (User = vmullan, | 1780 pages |
| | TimePeriod = YearToDate) | |
| 2006 05 30 | CumulativePrintCost | $4.70 |
| | (User = vmullan, | |
| | TimePeriod = Today) | |
| 2006 05 30 | CumulativePrintCost | $258.45 |
| | (User = vmullan, | |
| | TimePeriod = MonthToDate) | |
| 2006 05 30 | CumulativePrintCost | $974.22 |
| | (User = vmullan, | |
| | TimePeriod = YearToDate) | |
| 2006 05 30 | JobsMatchingRule | Rule ID Jobs Matched Times Presented |
| | (User = vmullan, | BR-601 - Color 2 2 |
| | TimePeriod = Today, RuleID) | BR-602 - Duplex 5 3 |
| | | BR-605 - Confidential 1 1 |
| 2006 05 30 | RuleComplianceRate | Rule ID Jobs Cancelled |
| | (User = vmullan, | BR-601 - Color 1 50% |
| | TimePeriod = Today, RuleID) | BR-602 - Duplex 0 0% |
| | | BR-605 - Confidential 1 100% |
| 2006 05 30 | JobsMatchingRule | Rule ID Jobs Matching |
| | (User = vmullan, | BR-601 - Color 91 40% |
| | TimePeriod = AllHistory, RuleID) | BR-602 - Duplex 182 80% |
| | | BR-603 - Sales web 0 0% |
| | | BR-604 - Photos 11 5% |
| | | BR-605 - Confidential 33 15% |
| | | BR-606 - Accounting Printer 2 1% |
| | | BR-607 - Accounting Documents 0 0% |
| 2006 05 30 | RuleComplianceRate | Rule ID Jobs Cancelled |
| | (User = vmullan, | BR-601 - Color 73 80% |
| | TimePeriod = AllHistory, RuleID) | BR-602 - Duplex 0 0% |
| | | BR-603 - Sales web N/A N/A |
| | | BR-604 - Photos 7 64% |
| | | BR-605 - Confidential 33 100% |
| | | BR-606 - Accounting Printer 2 100% |
| | | BR-607 - Accounting Documents N/A N/A |

### Example 2

### User Profile Data

For this example, the user profile data is illustrated in Table UP. Table UP depicts an example of end-user information provided to the rules system from the user database.

TABLE UP
Example User Profile

| Field Code Name | Example Value |
|---|---|
| UserName | vmullan |
| Communities | {Product Development, Marketing, |
| | Management, Calgary Staff} |
| Location.Organization | Product Development |
| Location.Country | Canada |
| Location.City | Calgary |
| Location.Site | Tower 1 |
| Location.Floor | 24 |
| Location.Zone | South West |

Table PJJ below illustrates data captured concerning a print job submitted but not yet printed; items printed in italics exemplify the job jacket data examined by the rules engine before allowing the job to proceed. In this example, the user is attempting to print 4 copies of an 84-page business plan.

TABLE PJJ
Example Enhanced Print Job Jacket

| Field Code Name | Example Value |
|---|---|
| PrintJobID | 12B9929A77C7992FF |
| TimeSubmitted | 2006:05:30 12:24 |
| TimeStarted | <N/A> |
| TimeCompleted | <N/A> |
| TimePosted | <N/A> |
| Priority | 99 |
| UserSubmitted | vmullan |
| UserNotify | vmullan |
| Workstation | CAL02 |
| Domain | Gotacopy.preo.ca |
| DocumentName | Business Plan.doc |
| PrinterPort | LPT2 |
| PrinterName | HP DeskJet 4700 |
| PrinterLocation | Development.Calgary.Tower1.24.SW |
| PrinterDriver | HP LaserJet 4700 MS |
| PrinterProcessor | WinPrint |
| Copies | 4 |
| Pages | 84 |
| SpoolSize | 2563456 bytes |
| PaperTray | 1 |
| PaperWidth | 120 mm |
| PaperLength | 240 mm |
| PaperOrientation | 1 (Portrait) |
| ColorMode | 2 (On) |
| ColorCoverage | 15% |
| BlackCoverage | 18% |
| ColorPagesCount | 49 |
| PrintQuality | 1 (High) |
| PrintResolution | 600 dpi |
| ColorDepth | 32 bits/pixel |
| nUp | 1 page per sheet |
| DuplexMode | 1 (Single-sided) |
| Collate | 0 (No) |
| Cost | $50.40 |
| ChargeCode | <Not specified> |
| DocumentType | MSW (Microsoft Word) |
| DocumentControl | 0 (No control specified) |
| AuthorizationCode | <Not specified> |
| AuthorizingOfficer | <Not specified> |
| NotifiedOfficer | <Not specified> |
| KeyPhrases | {“product plan”, “confidential”, |
| | “share offering”} |

### Example 3

### Processing of Business Rules

By way of illustration, consider the processing of the example business rules given below on the print job described in Table PJJ for the user profile shown in Table UP and subset of print history shown in Table HPR.

### Example Business Rules

### Business Rule BR-601

Title

Limit Unnecessary Color Printing

Policy Description
Intercept color print jobs and advise the user to resubmit in black & white if possible, or provide a reason or charge-out to a client. This policy applies to all staff other than Executives or those whose job inherently requires color printing (in which case it can be charged to an account).

Conditions

Job cost exceeds $0.50

Job is in color

User is not a member of {Executive}

Actions

Pause print job

Display User Dialog:
Message: “To reduce costs, please resubmit this job in black & white, or else charge it out or provide a reason for printing in color.”
Dialog option: Charge to Account
Dialog option: Reason for Printing
Help text: “Color printing generally costs 5 times as much as black & white. To help us reduce costs, press Cancel Job and then resubmit the print job in black & white. To set up black & white printing, choose Monochrome or Grayscale in the Print dialog.”
Response buttons: {Print, Cancel Job (default)}

### Business Rule BR-602

Title

Encourage Duplexing

Policy Description
Intercept single-sided print jobs and advise the user to resubmit in duplex if possible, or provide a reason or charge-out to a client. This policy applies to all staff.

Conditions

Job cost exceeds $0.25

Number of pages exceeds 1

Job is not duplex

Actions

Pause print job

Display User Dialog:
Message: “To support the Company's green initiative, please consider re-submitting this job double-sided (duplex).”
Dialog option: Charge to Account
Dialog option: Reason for Printing
Help text: “The Company is reducing paper consumption; printing double-sided reduces usage by nearly one half. To help save trees, press Cancel Job and then resubmit the print job in duplex. To set up duplex printing, choose Duplex or Double-Sided in the Print dialog.”
Response buttons: {Print, Cancel Job (default)}

### Business Rule BR-603

Title

Discourage Sales Staff from Printing Web-Pages

Policy Description
Sales staff have been printing off too many web pages. Intercept such print jobs and require a reason for printing.

Conditions

File type is one of {HTML, ASP, SWF, PHP}

User is a member of {Sales}

Actions

Pause print job

Display User Dialog:
Message: “You must provide a reason for printing off web pages.”
Dialog requirement: Reason for Printing
Help text: “Our print study found that web pages account for a significant portion of our overall print spend. To help us reduce costs, press Cancel Job and try to Save the web page to your hard drive rather than printing it. If you must print, you will have to enter the reason for doing so.”
Response buttons: {Print, Cancel Job (default)}

### Business Rule BR-604

Title

Charge Employees for Printing Photographs in Color

Policy Description

Recover the cost of printing photographs in color, either by charging the employee or an account.

Conditions

File type is one of {JPEG, TIFF, GIF}

Job is in color

Actions

Pause print job

Display User Dialog:
Message: “Printing of color images must be charged to an account.”
Dialog requirement: Charge to Account
Help text: “Color printing generally costs 5 times as much as black & white. To help us reduce costs, press Cancel Job or else charge it out to an account from which we might recover the cost. To charge out, fill in or choose the account name or number from the list.”
Response buttons: {Print, Cancel Job (default)}

### Business Rule BR-605

Title

Require Authorization to Print Confidential Documents

Policy Description
To ensure an audit trail for printing confidential documents, require an authorization code for each print job.

Conditions

Document keywords include some of {“confidential”, “secret”, “proprietary”}

Actions

Pause print job

Display User Dialog:
Message: “Please enter an authorization code to print this document.”
Dialog requirement: Authorization Code
Help text: “Confidential and sensitive documents require authorization to print. Please enter the authorization code; once it is validated by the system, your print job will be released. If you do not have a code, press Cancel Job and contact the appropriate person to obtain a code.”
Response buttons: {Print, Cancel Job (default)}

### Business Rule BR-606

Title

Require Authorization to Print Documents on Accounting Printers

Policy Description

To ensure an audit trail for printing accounting documents, require an authorization code for each print job.

Conditions

Printer location is one of {Accounting, Finance}

Actions

Pause print job

Display User Dialog:
Message: “Please enter an authorization code to print this document.”
Dialog requirement: Authorization Code
Help text: “Financial and accounting documents require authorization to print. Please enter the authorization code; once it is validated by the system, your print job will be released. If you do not have a code, press Cancel Job and contact the appropriate person to obtain a code.”
Response buttons: {Print, Cancel Job (default)}

### Business Rule BR-607

Title

Route all Accounting Documents to Secure Printer

Policy Description
To ensure an audit trail for printing accounting documents, require that they be printed on a secured accounting printer.

Conditions

File type is one of {ACCPAC, SAP, QBX}

Printer location contains one of {Accounting, Finance}

Actions

Cancel print job

Display User Dialog:
Message: “Please re-route this job to a secured printer in the Accounting section.”
Help text: “Financial and accounting documents must be sent to secure printers in Accounting offices. Please press Cancel Job and resubmit it to the appropriate printer.”
Response buttons: {Cancel Job (default)}

In this example, the evaluator selects the first business rule in the ruleset, which is rule BR-601. The evaluator will iterate over each condition in rule BR-601 until some condition does not match the current situation. The first condition, that the job's cost exceeds $0.50, does match, because the job costs $50.40. The second condition, that the job is in color, also matches. The third and final condition, that the user is not a member of the Executive community, also matches, because user “vmullan” belongs to Product Development, Marketing, Management, and Calgary Staff, but not Executive. Therefore, the evaluator exits the loop (2110) and marks rule BR-601 as “Passed”.

Table BREVAL below illustrates the process and results of matching business rules with the situation data. Note under “Test Result” that some conditions are not tested; this is because the previous condition tested FALSE and hence the rule failed. This process outputs the set of candidate business rules: {BR-601, BR-602, BR-605}.

TABLE BREVAL
Example of Evaluating Business Rules on Print Job Situation

| Rule ID | Condition | Corresponding Situation Data | Test Result |
|---|---|---|---|
| BR-601 | Job cost exceeds $0.50 | JobJacket.Cost = $50.40 | TRUE |
| BR-601 | Job is in color | JobJacket.ColorMode = 2 (On) | TRUE |
| BR-601 | User is not a member of | UserProfile.CommunityMemberships = {Product | TRUE |
| | {Executive} | Development, Marketing, | |
| | | Management, Calgary Staff} | |
| BR-601 | CONJUNCTION | | PASS |
| BR-602 | Job cost exceeds $0.25 | JobJacket.Cost = $50.40 | TRUE |
| BR-602 | Number of pages exceeds 1 | JobJacket.Pages = 84 | TRUE |
| BR-602 | Job is not duplex | JobJacket.DuplexMode = 1 (Single-sided) | TRUE |
| BR-602 | CONJUNCTION | | PASS |
| BR-603 | File type is one of {HTML, | JobJacket.DocumentType = MSW | FALSE |
| | ASP, SWF, PHP} | (Microsoft Word) | |
| BR-603 | User is a member of | UserProfile.CommunityMemberships = {Product | Not Tested |
| | {Sales} | Development, Marketing, | |
| | | Management, Calgary Staff} | |
| BR-603 | CONJUNCTION | | FAIL |
| BR-604 | File type is one of {JPEG, | JobJacket.DocumentType = MSW | FALSE |
| | TIFF, GIF} | (Microsoft Word) | |
| BR-604 | Job is in color | JobJacket.ColorMode = 2 (On) | Cached TRUE |
| BR-604 | CONJUNCTION | | FAIL |
| BR-605 | Document keywords | JobJacket.KeyPhrases = {“product plan”, | TRUE |
| | include some of | “confidential”, “share offering”} | |
| | {“confidential”, “secret”, | | |
| | “proprietary”} | | |
| BR-605 | CONJUNCTION | | PASS |
| BR-606 | Printer location contains | JobJacket.PrinterLocation = Development. | FALSE |
| | one of {Accounting, | Calgary.Tower1.24.SW | |
| | Finance} | | |
| BR-606 | CONJUNCTION | | FAIL |
| BR-607 | File type is one of | JobJacket.DocumentType = MSW | Cached |
| | {ACCPAC, SAP, QBX} | (Microsoft Word) | FALSE |
| BR-607 | Printer location contains | JobJacket.PrinterLocation = Development. | Cached |
| | one of {Accounting, | Calgary.Tower1.24.SW | FALSE |
| | Finance} | | |
| BR-607 | CONJUNCTION | | FAIL |

### Example 4

### Relations

Relations describe relationships among rules, such as priority order and grouping. The “Rule Class” relation enables grouping a number of rules under an equivalence class; other meta rules may refer to this attribute when determining how to prioritize rule firing. Note that a rule can belong to more than one class. Examples are given below.

Relation RC-701: Class (Cost Reduction, {Rule BR-601, Rule BR-603, Rule BR-604})

Relation RC-702: Class (Cost Recovery {Rule BR-601})

Relation RC-703: Class (Green Initiative, {Rule BR-602})

Relation RC-704: Class (Security, {Rule BR-605, Rule BR-606, Rule BR-607})
The “Priority Order” relation specifies the precedence in which rules are selected for firing in case several rules match the current print job. Examples are given below.

Relation PO-709: Priority (Security, Cost Recovery, Cost Reduction, Green Initiative)
In this example, Security rules have the highest priority; Green Initiative rules have the lowest. By implication, therefore, Rules BR-605, BR-606 and BR-607 all take precedence over BR-601 and BR-604, which in turn take precedence over BR-603, which takes precedence over BR-602.

Relation PO-710: Priority (Rule BR-605, Rule BR-606)
Rule BR-605 takes precedence over BR-604 in case both match the current situation.

Relation PO-711: Priority (Rule BR-603, Rule BR-601)
Rule BR-603 takes precedence over BR-601 in case both match the current situation.
All priority relations are evaluated, and the highest precedence or most specific reference applies. Since BR-601 occurs in both the Cost Recovery and Cost Reduction classes it would take precedence over BR-603 by default. However, BR-603 is explicitly declared to have higher priority than BR-601; therefore, BR-601 takes precedence.

### Example 4

### Meta Rules

Meta-Rules govern the selection of rules on which to take action. Given a set of business rules, it is possible that several may match the current situation; meta-rules can be used to select among them. Meta-rules can also be used to express policies that govern the presentation of rule actions, based on patterns of user behavior. Meta-rules are expressed in condition:action form, referring to any attribute of the current print job, print history, user profile, or relations among rules. Examples are given below.

### Meta-Rule MR-712

Title

Do not Impose Cost Reduction or Green Initiative Interventions on Already-Compliant Users

Policy Description
To avoid antagonizing users who generally comply with rules, allow occasional violations to pass without interference, provided the job costs less than $5.

Conditions

Rule class is one of {Cost Reduction, Green Initiative}

Rule action is not mandatory

User's compliance with rule is at least 75%

Rule matches less than 10% of user's print jobs

Print job cost is less than $5.00

Actions

Suppress rule action

Record rule match, flag action suppressed by Rule MR-712

### Meta-Rule MR-713

Title

Limit Frequency of Cost Reduction and Green Initiative Dialogs.

Policy Description
To minimize interference with users' work, avoid presenting cost reduction or green initiative dialogs more than 3 times in one day.

Conditions

Rule class is one of {Cost Reduction, Green Initiative}

Rule action is not mandatory

Count of rule interactions with user exceeds 2 within time period of today

Actions

Suppress rule action

Record rule match, flag action suppressed by Rule MR-713

### Meta-Rule MR-714

Title

Do not Impose Rules on Executive Staff Unless Specifically Directed

Policy Description
To avoid antagonizing Executive users, do not present rule dialogs unless a rule relates to Security or is specifically targeted to Executives.

Conditions

User is a member of {Executive}

Rule class is not one of {Security}

List of user memberships in rule does not include {Executive}

Actions

Suppress rule action

Record rule match, flag action suppressed by Rule MR-714

### Final Selection Meta-Rule MR-715

Title

Present Only One Action or Recommendation to the User at a Time.

Policy Description
To Avoid Confusing Users, Take Only the Action of the Highest-Priority Rule that Applies to the Current Situation.

Conditions

Number of rules matching current situation exceeds 1

Actions

Select rule with highest priority in set of Rule Priority relations

Suppress all other rule actions

Record all other rule matches, flag action suppressed by Rule MR-715

### Active Ruleset

### Business Rules

### Rules {BR-601, BR-602, BR-603, BR-604, BR-605, BR-606, BR-607}

### Relations

### Relations {RC-701, RC-702, RC-703, RC-704, PO-709, PO-710, PO-711}

### Meta Rules

### Rules {MR-712, MR-713, MR-714, MR-715}

### Example 6

### Evaluation Meta-Rules on Candidate Ruleset

The evaluation of meta-rules on the candidate ruleset comprising {BR-601, BR-602, BR-605} from Example 4 is shown here. The evaluator iterates over the set of candidates, commencing with rule BR-601. The next loop iterates over the set of meta-rules, commencing with rule MR-712. The inner loop iterates over rule MR-712's conditions until one fails or all pass.

The first condition of rule MR-712 checks whether the current business rule belongs to one of the following classes: Cost Reduction (Relation RC-701), or Green Initiative (Relation RC-703). business rule BR-601 does appear in Relation RC-701, hence this condition passes. This condition and the result for business rule BR-601 are stored in the test results cache.

The second condition of rule MR-712 checks whether BR-601's action is mandatory. Here, “mandatory” means that the user cannot choose to print the job without taking some action required by the rule in the user dialog, either because Cancel Job is the only option provided, or because the dialog includes some required data field which the user must fill in for the Print button to be enabled.

The third condition of rule MR-712 checks whether the user has complied with the current business rule on at least 75% of the occasions when it was presented; here “complied with” means that the user either cancelled the job or entered any required information. In the example, rule BR-601 pauses a color print job and recommends re-submitting it in black & white. Whenever vmullan pressed “Cancel Job”, his response was counted as complying; whenever he clicked “Print”, his response was counted as not complying. To verify compliance, the meta-rules evaluator examines vmullan's print history. In this example, the summary data for RuleComplianceRate shows that user vmullan clicked “Cancel Job” on 80% of the occasions on which rule BR-601 was presented to him. Therefore, this condition passes.

The fourth condition of rule MR-712 checks the frequency with which the user's printing behavior violates the current business rule, indicating that, although the user is compliant, they have not yet learned to modify their behavior. Rule MR-712 will suppress a business rule if fewer than 10% of the user's print jobs triggered it. In this example, 40% of vmullan's print jobs violated (i.e. match) rule BR-601; therefore, this condition fails, and hence rule MR-712 fails.

At this point, rule BR-601 is still in the candidate ruleset, and processing continues with meta-rule MR-713. The results of evaluating all the meta-rules is shown in Table MREVAL. Since no meta-rule matches BR-601 in the current situation, BR-601 remains in the candidate ruleset, and processing continues with business rule BR-602.

The processing of the rest of the candidate business rules is depicted in Table MREVAL. The main loop exits with filtered candidate ruleset {BR-601, BR-605}. Table MREVAL below illustrates the process of testing meta-rules on the candidate business rules output from the business rules evaluation above. Meta-rules are tested on each candidate business rule in turn. Note under “Test Result” that meta-rule MR-714 is not tested on BR-602; this is because MR-713 already passed and removed BR-602 from the set of candidates.

TABLE MREVAL
Example of Evaluating Meta-Rules on Candidate Business Rules and Print Job Situation

| | | | |
|---|---|---|---|
| Rule ID | Condition | Corresponding Situation Date | Test Result |

Testing Business Rule BR-601

| | | | |
|---|---|---|---|
| MR-712 | Rule class is one of {Cost | RC-701: Rule Class (Cost Reduction, | TRUE |
| | Reduction, Green | {Rule BR-601, Rule BR-603, Rule BR- | |
| | Initiative} | 604}) | |
| MR-712 | User's compliance with rule | PrintHistory.CumulativeRule- | TRUE |
| | is at least 75% | ComplianceRates (BR-601, 80%) | |
| MR-712 | Rule matches less than 10% | PrintHistory.CumulativeJobs- | FALSE |
| | of user's print jobs | MatchingRules (BR-601, 40%) | |
| MR-712 | Print job cost is less than | | Not Tested |
| | $10.00 | | |
| MR-712 | CONJUNCTION | | FAIL |
| MR-713 | Rule class is one of {Cost | | Cached |
| | Reduction, Green | | □TRUE |
| | Initiative} | | |
| MR-713 | Count of rule interactions | PrintHistory.DailyJobsMatchingRules | FALSE |
| | with user exceeds 2 within | (2006 05 30, BR-601, 2, 2) | |
| | time period of today | | |
| MR-713 | CONJUNCTION | | FAIL |
| MR-714 | User is a member of | UserProfile.CommunityMemberships = {Product | FALSE |
| | {Executive} | Development, Marketing, | |
| | | Management, Calgary Staff} | |
| MR-714 | Rule class is not one of | | Not Tested |
| | {Security} | | |
| MR-714 | List of user memberships in | | Not Tested |
| | rule does not include | | |
| | {Executive} | | |
| MR-714 | CONJUNCTION | | FAIL |

Testing Business Rule BR-602

| | | | |
|---|---|---|---|
| MR-712 | Rule class is one of {Cost | RC-703: Rule Class (Green Initiative, | TRUE |
| | Reduction, Green | {Rule BR-602}) | |
| | Initiative} | | |
| MR-712 | User's compliance with rule | PrintHistory.CumulativeRule- | FALSE |
| | is at least 75% | ComplianceRates (BR-602, 0%) | |
| MR-712 | Rule matches less than 10% | | Not Tested |
| | of user's print jobs | | |
| MR-712 | Print job cost is less than | | Not Tested |
| | $5.00 | | |
| MR-712 | CONJUNCTION | | FAIL |
| MR-713 | Rule class is one of {Cost | | Cached |
| | Reduction, Green | | □TRUE |
| | Initiative} | | |
| MR-713 | Count of rule interactions | PrintHistory.DailyJobsMatchingRules | TRUE |
| | with user exceeds 2 within | (BR-602, 5, 3) | |
| | time period of today | | |
| MR-713 | CONJUNCTION | | PASS |
| MR-714 | User is a member of | | Not Tested |
| | {Executive} | | |
| MR-714 | Rule class is not one of | | Not Tested |
| | {Security} | | |
| MR-714 | List of user memberships in | | Not Tested |
| | rule does not include | | |
| | {Executive} | | |
| MR-714 | CONJUNCTION | | NOT |
| | | | TESTED |

Testing Rule BR-605

| | | | |
|---|---|---|---|
| MR-712 | Rule class is one of {Cost | RC-704: Rule Class (Security, {Rule BR- | FALSE |
| | Reduction, Green | 605, Rule BR-606, Rule BR-607}) | |
| | Initiative} | | |
| MR-712 | User's compliance with rule | | Not Tested |
| | is at least 75% | | |
| MR-712 | Rule matches less than 10% | | Not Tested |
| | of user's print jobs | | |
| MR-712 | Print job cost is less than | | Not Tested |
| | $5.00 | | |
| MR-712 | CONJUNCTION | | FAIL |
| MR-713 | Rule class is one of {Cost | | Cached□FALSE |
| | Reduction, Green | | |
| | Initiative} | | |
| MR-713 | Count of rule interactions | | Not Tested |
| | with user exceeds 2 within | | |
| | time period of today | | |
| MR-713 | CONJUNCTION | | FAIL |
| MR-714 | User is a member of | | Cached□FALSE |
| | {Executive} | | |
| MR-714 | Rule class is not one of | | Not Tested |
| | {Security} | | |
| MR-714 | List of user memberships in | | Not Tested |
| | rule does not include | | |
| | {Executive} | | |
| MR-714 | CONJUNCTION | | FAIL |

### Example 7

### Selection of Rules to Fire

In this example, MR-715 specifies that 1 rule fire: in particular, the rule having the highest rank in the Priority relations. The evaluator for Priority relations checks both the ranking of classes and individual rules; the latter overrides the former in case of a conflict. In this example, Relation PO-709: Priority of Classes (Security, Cost Recovery, Cost Reduction, Green Initiative) implies that BR-605 has priority over BR-601. No other ranking applies to these rules. Therefore, the rules engine selects BR-605 to fire.

The rules engine sends the selected rule BR-605 to the user behavior interface for execution in the client computer's user interface (step 1110). The user behavior interface interprets BR-605's action, by parsing the XML data block as illustrated in Table XMLRULE. The rule's actions are executed in sequence. First, the print job is removed from the queue (if this was not done so already during rule processing) and put into a holding queue. In a typical embodiment of the invention, rules could be represented in a dialect of the eXtensible Markup Language (XML). Table XMLRULE depicts a possible representation of Business Rule BR-605. The behavior interface may then generate a user interface dialog with the attributes listed in Table XMLRULE (step 1120). For illustrative purposes, the dialog might appear as in FIG. 6.

The final selection meta-rule it determines the conditions under which 0 or 1 of the candidate business rules will fire. In this example, MR-715 specifies that one rule fires: in particular, the rule having the highest rank in the Priority relations.

The evaluator for Priority relations checks both the ranking of classes and individual rules; the latter overrides the former in case of a conflict. In this example, Relation PO-709: Priority of Classes (Security, Cost Recovery, Cost Reduction, Green Initiative) implies that BR-605 has priority over BR-601. No other ranking applies to these rules. Therefore, the rules engine selects BR-605 to fire.

TABLE XMLRULE
Example XML Representation of Business Rule

```
<Business_Rule>
    ID = “BR-605”;
  Title = “Require authorization to print confidential documents”
  Policy_Description = “To ensure an audit trail for printing confidential
documents, require an authorization code for each print job.”
  <Conditions Logic = “Conjunction”>
    <Test>
      Attribute = “JobJacket.Keyphrases”
      Operator = “Includes_Some”
      Value = <List “product plan”, “confidential”, “share offering” />
    </Test>
  </Conditions>
  <Actions>
    Schedule = “Immediate”
    Print_Job_Queue = “Pause_Print_Job”
    <User_Dialog>
      Dialog_Type = “Modal”
      Message = “Please enter an authorization code to print this
      document.”
      Show_Job_Cost = “True”
      <Data_Entry>
        <Authorization_Code Usage = “Required”/>
      </Data_Entry>
      Help_Text = “Confidential and sensitive documents require
    authorization to print. Please enter the authorization code; once it is
    validated by the system, your print job will be released. If you do not
    have a code, press Cancel Job and contact the appropriate person
    to obtain a code.”
      <User_Responses>
        <Print/>
        <Cancel_Job Focus = “Default”/>
      </User_Responses>
    </User_Dialog>
  </Actions>
</Business_Rule>
```

### Example 8

### User Response to Business Rule Actions

In a typical embodiment of the invention, the data collector could represent the user's response to business rule actions in the form of an XML data block, as illustrated in Table USERINPUT below. The table presents data from the worked example.

TABLE USERINPUT
Example Record of User Input to Business Rule Dialog

```
<User_Response>
    Business_Rule = “BR-605”
    Start_Date = “2006 05 30”
    Start_Time = “12:25:03”
    End_Date = “2006 05 30”
    End_Time = “12:25:42”
    User = “vmullan”
    <User_Action_Sequence>
        <Data_Entry>
            Field = “Authorization_Code”
            Value = “XYZ”
        </Data_Entry>
        <Button_Press Button = “Print” />
        <System_Response>
            Code = “INVALAUTHCODE”
            Result = “Retry”
        </System_Response>
        <Data_Entry>
            Field = “Authorization_Code”
            Value = “x67y43z29”
        </Data_Entry>
        <Button_Press Button = “Print” />
        <System_Response>
            Code = “OK”
            Result = “Done”
        </System_Response>
    </User_Action_Sequence>
    <User_Response_Summary>
        All_Required_Fields_OK = “True”
        Required_Fields_Filled = <List “Authorization_Code” />
        Optional_Fields_OK = “N/A”
        Optional_Fields_Filled = “”
        Final_Button_Pressed = “Print”
        Final_System_Response = “OK”
    </User_Response_Summary>
</User_Response>
```

Each element of the dialog is generated by interpreting a tag or attribute thereof in the XML specification. The overall dialog layout is determined by the <User_Dialog> tag. The text at the top (“Please enter an authorization code to print this document.”) is generated from the “Message” attribute of the <User_Dialog> tag. The data-entry field labeled “Authorization Code” is generated from the <Authorization_Code> tag; since it's Usage property equals “Required”, the generator inserts the asterisk and note that this field is required. The generator for the Help_Text attribute inserts the text “Click here for more information and advice” and the logic that brings up the help text in a new window when the user clicks on the hyperlink. Finally, the generator for the <User_Responses> tag inserts the Print and Cancel Job buttons, making Print the default selection. The generator for the Required Usage property inserts logic that disables the Print button until the user has entered text in the Authorization Code field.

For purposes of illustration, let us suppose that user vmullan initially responds to the user dialog for BR-605 by entering an invalid authorization code “XYZ” and then presses Print. When validation fails, vmullan is asked to re-enter the code. He then enters the correct code “x67y43z29” and presses Print. The user behavior interface captures all these inputs, together with their corresponding user dialog element and system response. This record could be implemented as an XML data block, which might appear similar to that illustrated in Table USERINPUT.

In this example, the <User_Response_Summary> tag captures the information essential to tracking compliance with the business rule. In this case, compliance is implied according to the criteria noted above.

The functionality and features associated with the print management system, associated devices and/or algorithms as described above in accordance with the embodiments may be implemented in the form of one or more software objects, modules, code components, or computer programs or program modules. Further, at least some or all of the software objects can be hard-coded into central processing units and/or read only memories or other non-volatile storage media in the mobile communication device, server and/or other components or modules depicted in the drawings. The specific implementation details of the software objects and/or program modules will be within the knowledge and understanding of one skilled in the art.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A computer-implemented method of print management initiated upon detection of a print job requested by an end-user, said method comprising:
(a) obtaining information about the print job and the end-user to create a print situation;
(b) applying a set of business rules to the print situation to create a candidate set of zero or more business rules;
(c) applying a set of meta-rules to the candidate set of business rules to choose zero or more business rules to fire;
(d) if a business rule is chosen to fire, applying an action associated with the chosen business rule;
(e) observing a user response to the action; and
(f) recording the print situation, the candidate set of business rules, the meta-rules matched, the business rule chosen, and user response, all to a print usage database.

2. The method of claim 1 wherein the information about the end-user comprises a user profile and a user print history.

3. The method of claim 1 wherein the step of applying a set of meta-rules to the candidate set of business rules results in removal of the business rule from the candidate set of business rules, or suppression or modification of the action associated with a chosen business rule.

4. The method of claim 1 wherein the set of meta-rules comprises a final selection meta-rule which selects a single business rule to fire from the chosen business rules.

5. The method of claim 4 wherein the final selection meta-rule selects a business rule to fire based on a pre-determined priority between the chosen business rules.

6. The method of claim 1 wherein the business rules are categorized into pre-defined groups.

7. The method of claim 6 wherein the pre-defined groups comprise two or more of a cost control group, a cost recovery group, a waste reduction group, and a security or privacy group.

8. The method of claim 6 wherein individual meta-rules apply to one or more business rule groups, and do not apply to one or more business rule groups.

9. The method of claim 3 wherein one meta-rule confirms, modifies or suppresses the action associated with a business rule based on the user's print history.

10. The method of claim 3 wherein one meta-rule confirms, modifies or suppresses the action associated with a business rule based on the user profile.

11. The method of claim 1 wherein the creation of a candidate set of business rules, and the application of meta-rules to the candidate set of business rules are separate steps.

12. The method of claim 11 wherein the creation of a candidate set of business rules, and the application of meta-rules to the candidate set of business rules are sequential steps.

13. The method of claim 1 wherein the action associated with a chosen business rule comprises one or more of the following:
(a) the presentation of information to the end-user;
(b) a request for information from the end-user;
(c) a request for a choice or decision by the end-user;
(d) a report of the print situation and chosen business rule to another person;
(e) a modification to the print job.

14. The method of claim 13 wherein the action comprises the presentation of a user interface dialog which may allow the print job to proceed, display the cost of the print job, require the user to enter an authorization code, deny the print job, or require or recommend an alternative to the user, singly or in combinations thereof.

15. The method of claim 1 wherein the information about the print job includes one or more key words or phrases from a document to be printed.

16. A server-based print management system comprising:
(a) a business rule database,
(b) a meta-rules database;
(c) a print usage database; and
(d) a communication interface configured to communicate with a client based system comprising a client print system, a rules engine, a usage data collector, and a user interface;
(e) wherein the usage data collector is configured to observe end-user print behavior and record it to the print usage database, and the rules engine is configured to analyze a print job situation by applying business rules to the situation, and meta-rules to the applied business rules and situation.

17. The system of claim 16 further comprising a rules editor configured to add, remove or modify rules to, from or within the business rule database and the meta-rules database.

18. The system of claim 17 further comprising a rule simulator configured to test a new rule or a modified rule against the print usage database to determine its effect prior to addition or modification of the business rule or the meta-rule.

19. A client based print management system for use with a client print system, said print management system comprising:
(a) a rules engine;
(b) a usage data collector;
(c) a user interface; and
(d) a communication interface configured to communication with a server based system comprising a business rules database, a meta-rules database, and a print usage database;
(e) wherein the usage data collector is configured to create a print situation and observe end-user behavior, and record information to the print usage database, and wherein the rules engine is configured to receive the print situation and apply business rules to the situation, and apply meta-rules to the applied business rules and the situation, and if a business rule is chosen to fire, execute an action associated with the chosen business rule, the action as modified by the application of the meta-rules thereto.
